(19) United States
(12) Patent Application Publication
(10) Pub. No.: US 2020/0040119 A1
(43) Pub. Date: Feb. 6, 2020

(54) BLOCK COPOLYMER AND PREPARATION METHOD AND APPLICATION THEREOF

(71) Applicant: Fudan University, Shanghai (CN)

(72) Inventors: Hai DENG, Shanghai (CN); Chenxu WANG, Shanghai (CN); Zhilong LI, Shanghai (CN); Xuemiao LI, Shanghai (CN)

(73) Assignee: Fudan University, Shanghai (CN)

(21) Appl. No.: 16/177,773

(22) Filed: Nov. 1, 2018

(30) Foreign Application Priority Data
Aug. 1, 2018 (CN) 201810863466.2
Aug. 17, 2018 (CN) 201810943217.4

(51) Int. Cl. C08F 293/00; C08F 212/14; C08F 220/18; C08F 230/08

(52) U.S. Cl. CPC C08F 293/005; C08F 212/14; C08F 2438/01; C08F 230/08; C08F 220/18

(57) ABSTRACT

The present invention discloses a block copolymer comprising at least a block A and a block B, wherein the monomer of block A contains one or more of the structural units:

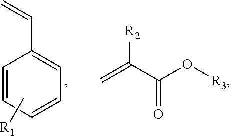

a C3-C6 alkenyl group containing a substituent or a C3-C6 alkenyl group; wherein the number of R₁ is 0, 1, 2, 3, 4 or 5; R₂ is selected from the group consisting of: absent, substituted or unsubstituted C1-C6 alkyl, substituted or unsubstituted C1-C6 alkoxyl, hydroxyl, halogen; “substituted” means a group is substituted by one or more substituents selected from halogen and hydroxyl; block B is obtained by polymerization of the monomer

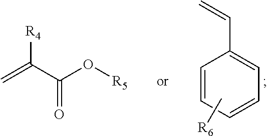

R₆ is selected from F or a group containing F, and the number of R₆ is 0, 1, 2, 3, 4 or 5. The block copolymer can assemble rapidly at a low temperature with self-repairing performance to reduce the defect rate.

### REFERENCE TO RELATED APPLICATION

This application claims the priorities of Chinese patent application No. 201810863466.2 entitled “An ultrahigh resolution block copolymer containing fluorine and oxygen and preparation method and application thereof” filed on Aug. 1, 2018 and Chinese patent application No. 201810943217.4 entitled “A class of highly ordered block polymer materials and preparation method and application thereof” filed on Aug. 17, 2018.

### FIELD OF THE INVENTION

The present invention relates to the field of material, in particular to a block copolymer and preparation method and application thereof.

### BACKGROUND OF THE INVENTION

A block copolymer, also known as a mosaic copolymer, is a special polymer prepared by linking two or more polymer chain segments having different properties together. A block copolymer with a specific structure will exhibit different properties from simple linear polymers and many mixtures of random copolymers and even homopolymers. Therefore, block copolymers are used as thermoplastic elastomers, blend compatibilizers, and interface modifiers, etc., which have broad application prospects in many fields such as biomedicine, photolithography, construction and chemical industry.

Photolithography is a technique by which a pattern on a mask plate is transferred to a substrate by means of a photo-resist (also known as a photoresist, mainly containing a copolymer) under light. Photolithography becomes more and more important as semiconductor is developing rapidly in China. However, since the traditional block copolymer material has two blocks of purely organic structures, it has poor etching contrast, and the pattern transfer is difficult to be completed. The two blocks of the conventional block copolymer material carry no special functional groups, thus it has no prospect of being functionalized later.

In addition, it is difficult for traditional photolithography to break through a scale of 10 nm due to the limitations brought by light scattering effect and processing technologies. It is a potential alternative method for preparing highly ordered nanostructures by self-assembly using microphase separation of block copolymers. The block copolymer materials in the prior art (e.g., polystyrene-block-poly(methyl methacrylate), PS-b-PMMA)) require higher annealing temperature (above 160° C.) and a longer annealing time to perform complete self-assembly, which makes it increasingly difficult to meet actual production requirements (especially of photolithography). After self-assembling on a wafer, such materials have a higher defect rate, further limiting their use in actual production.

In view of the above, it is of great significance to provide a block copolymer which can self-assemble into a pattern of 10 nm or less and can be functionally modified, and a preparation method thereof, so as to meet the actual production requirements.

### SUMMARY OF THE INVENTION

The technical problem to be solved by the present invention is to provide a highly ordered block copolymer material which can rapidly self-assemble in a short time under a low temperature or even room temperature condition, with a potential self-repairing property, a good etching contrast between its components as well as a beneficial property for pattern transfer, and a preparation method and an application thereof.

In order to solve the above technical problem, the technical solution adopted by the present invention is described as below. A block copolymer is provided comprising at least a block A and a block B, wherein the monomer of block A is selected from the group consisting of:

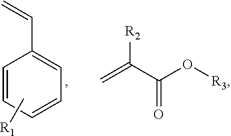

C3-C6 alkenyl having a substituent or C3-C6 alkenyl;

wherein R₁ is selected from the group consisting of H, substituted or unsubstituted silane group containing 1-5 Si atom(s), substituted or unsubstituted germane group containing 1-5 Ge atom(s), substituted or unsubstituted stannane group containing 1-5 Sn atom(s), substituted or unsubstituted C1-C10 alkyl group, substituted or unsubstituted hydrocarbyloxy group, substituted or unsubstituted ester group, substituted or unsubstituted C3-C6 cycloalkyl group, substituted or unsubstituted C6-C10 aryl group, substituted or unsubstituted heteroaryl group containing 1-3 heteroatoms selected from N, O, and S, hydroxyl group, and halogen; wherein “substituted” means a group is substituted by one or more substituents selected from the group consisting of C1-C6 alkyl, silane group containing 1-5 Si atom(s), C1-C6 alkoxyl-substituted silane group containing 1-5 Si atom(s), silyloxy group containing 1-5 Si atom(s), silyloxy group containing 1-5 Si atom(s) substituted by silyloxy group containing 1-5 Si atom(s), C1-C6 alkoxyl group, and hydroxyl group;

the number of R₁ is 0, 1, 2, 3, 4 or 5;

R₂ is selected from the group consisting of: absent, substituted or unsubstituted C1-C6 alkyl, substituted or unsubstituted C1-C6 alkoxyl, hydroxyl, halogen; “substituted” means that a group is substituted by one or more substituents selected from the group consisting of halogen, and hydroxyl;

R₃ is selected from the group consisting of substituted C1-C10 alkyl, substituted or unsubstituted C3-C6 cycloalkyl, substituted or unsubstituted C6-C10 aryl, substituted or unsubstituted C6-C10 heteroaryl group containing 1-3 heteroatoms selected from N, O, and S, substituted or unsubstituted silane group containing 1-5 Si atom(s), substituted or unsubstituted germane group containing 1-5 Ge atom(s), substituted or unsubstituted stannane group containing 1-5 Sn atom(s); “substituted” means that a group is substituted by one or more substituents selected from the group consisting of C1-C6 alkyl, silane group containing 1-5 Si atom(s), C1-C6 alkyl-substituted silane group containing 1-5 Si atom(s), C1-C6 alkyl-substituted silyloxy group containing 1-5 Si atom(s), silane group containing 1-5 Si atom(s) substituted by silyloxy group containing 1-5 Si atom(s), C1-C6 alkoxyl-substituted silane group containing 1-5 Si atom(s), silyloxy group containing 1-5 Si atom(s), and C1-C6 alkyl-substituted caged siloxane group containing 4-10 Si atoms;

in the substituted or unsubstituted C3-C6 alkenyl group, “substituted” means that the group is substituted by one or more substituents selected from the group consisting of: silyloxy group containing 1-5 Si atom(s), silane group containing 1-5 Si atom(s), C1-C6 alkyl-substituted silane group containing 1-5 Si atom(s), C1-C6 alkoxyl-substituted silane group containing 1-5 Si atom(s), and C6-C10 aryl-substituted silane group containing 1-5 Si atom(s);

the block B is obtained by polymerization of any of the following monomers:

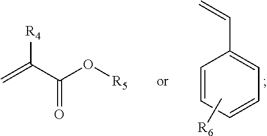

wherein, R₄ is selected from the group consisting of: absent, substituted or unsubstituted C1-C6 alkyl, substituted or unsubstituted C1-C6 alkoxyl, hydroxyl, halogen; “substituted” means that the group is substituted by one or more substituents selected from the group consisting of: halogen, and hydroxyl;

R₅ is selected from the group consisting of: substituted benzyl, substituted C3-C30 alkyl; “substituted” means that the group is substituted by 1-3 hydroxyl groups and/or 5-20 F atoms;

provided that: when block A is obtained by polymerization of

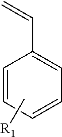

in which R₁ is absent, R₅ is a substituted benzyl group;

R₆ is selected from the group consisting of F or a group containing F, and the number of R₆ is 0, 1, 2, 3, 4 or 5.

Preferably, the monomer of the block A is selected from the following compounds: an alkoxy-substituted styrene compound, a vinyl phenol ester compound, a methacrylic acid phenolic ester or an acrylic acid phenol ester compound having an ester group in an aryl group.

Preferably, the number of alkyl group in the hydrocarbyloxy group or the ester group is 0-20.

Preferably, block A is obtained by polymerization of a monomer selected from the group consisting of:

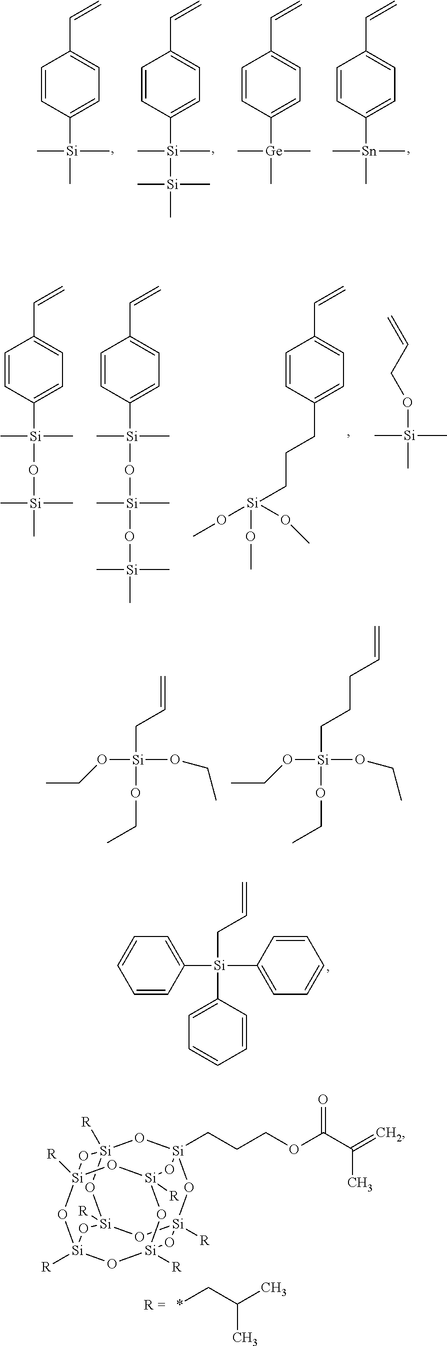

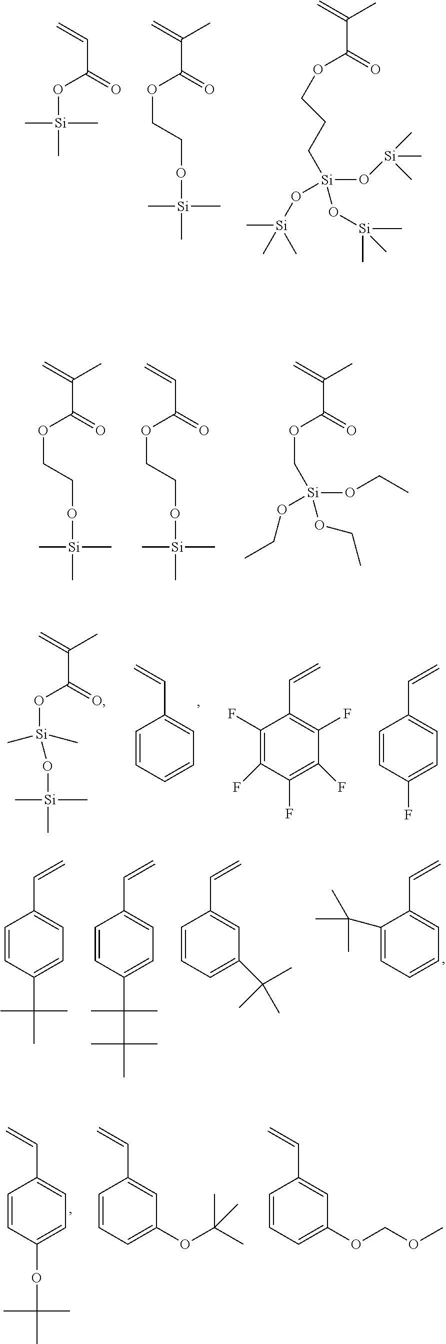

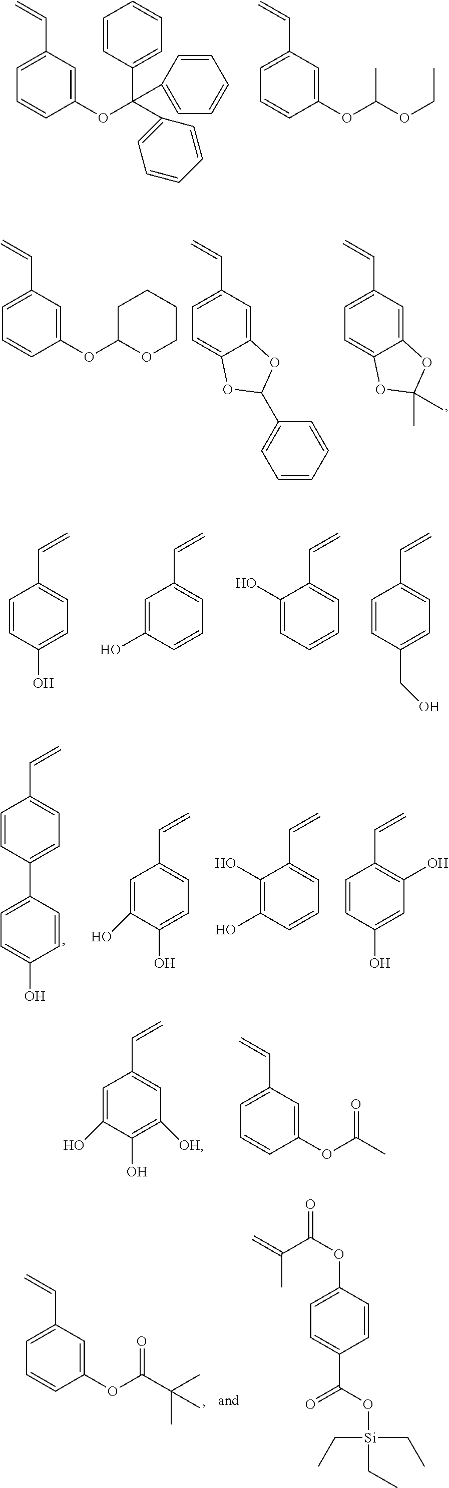

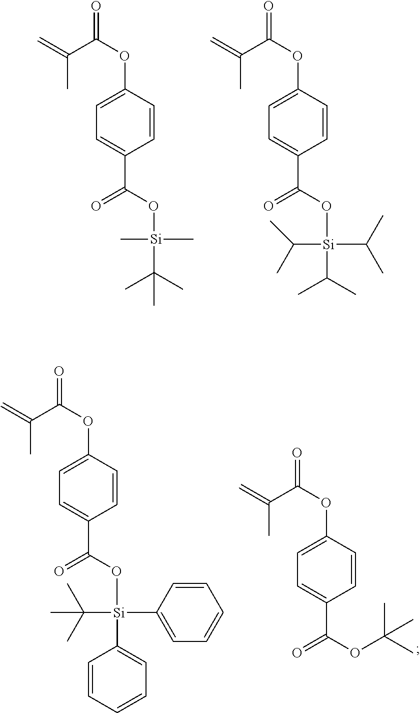 [SMILES: C=C(C)C(=O)Oc1ccc(C(=O)O[Si](C)(C)C(C)(C)C)cc1 ; C=C(C)C(=O)Oc1ccc(C(=O)O[Si](C(C)C)(C(C)C)C(C)C)cc1 ; C=C(C)C(=O)Oc1ccc(C(=O)O[Si](c2ccccc2)(c2ccccc2)C(C)(C)C)cc1 ; C=C(C)C(=O)Oc1ccc(C(=O)OC(C)(C)C)cc1]

block B is obtained by polymerization of a monomer selected from the group consisting of:

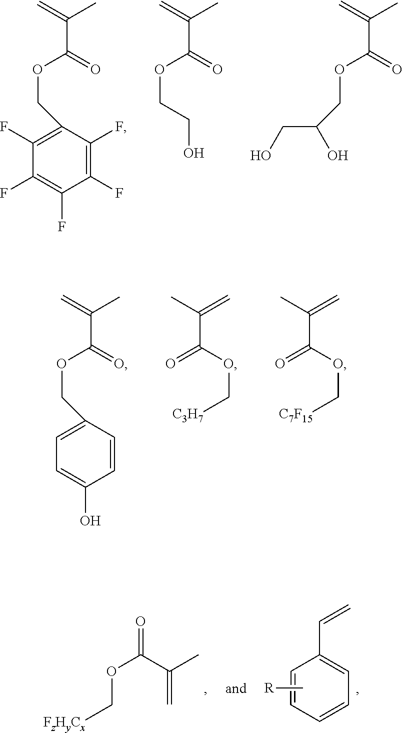

wherein, the x, y, and z are any natural numbers, and the R is F or —CF₃ or —COCF₃.

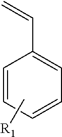

Preferably, when block A is obtained by polymerization of in which R₁ is absent, the molecular weight of the block copolymer is in a range of 2000-30000, preferably 3000-25000, more preferably 8000-25000, even more preferably 10000-25000 and most preferably from 13000-23000.

Preferably, the block copolymer has a di-block structure of (A)ₘ-(B)ₙ or a tri-block structure of (B)ₙ₁-(A)ₘ-(B)ₙ₂. Preferably, the block copolymer has characteristics selected from the group consisting of:

1) m/n=0.2-5; preferably 0.7-4.6;

2) m/(n1+n2)=0.2-5; preferably 0.7-4.6;

Preferably, the block copolymer has at least one of the following characteristics:

1) polydispersity PDI≤2.0, preferably PDI≤1.30, preferably PDI≤1.25, more preferably PDI≤1.20, more preferably PDI≤1.15, and still more preferably PDI≤1.10;

2) the average molecular weight is in a range of 1000-200000, preferably 2000-50000, more preferably 2000-30000, more preferably 2000-10000, still more preferably 2000-5000; when the block A is obtained not by polymerization of

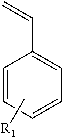

in which R₁ is absent, the block copolymer has a number average molecular weight of 1000-120000;

3) the annealing temperature required for phase separation and self-assembly is ≤200° C., preferably ≤160° C., more preferably ≤120° C., more preferably ≤100° C., still more preferably ≤80° C., and most preferably ≤50° C.; when block A is obtained not by polymerization of

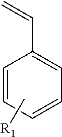

in which R₁ is absent, the annealing temperature required for phase separation and self-assembly of the block copolymer is ≤100° C.; and/or the annealing time required for phase separation and self-assembly of the block copolymer is ≤10 min, preferably ≤6 min;

4) the annealing time required for phase separation and self-assembly is ≤24 h, preferably ≤5 h, more preferably ≤1 h, more preferably ≤15 min, still more preferably ≤5 min, and most preferably ≤1 min; when block A is obtained by polymerization of

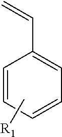

in which R₁ is absent, the annealing temperature required for phase separation and self-assembly of the block copolymer is ≤180° C. and preferably ≤170° C.; and/or the annealing time required for phase separation and self-assembly of the block copolymer is ≤12 h;

5) the assembly pitch of the product obtained by self-assembly is ≤50 nm, preferably ≤30 nm, preferably ≤20 nm, preferably ≤15 nm, more preferably ≤10 nm, and most preferably ≤5 nm (i.e., half-pitch≤5 nm).

Preferably, the block copolymer is selected from the group consisting of:

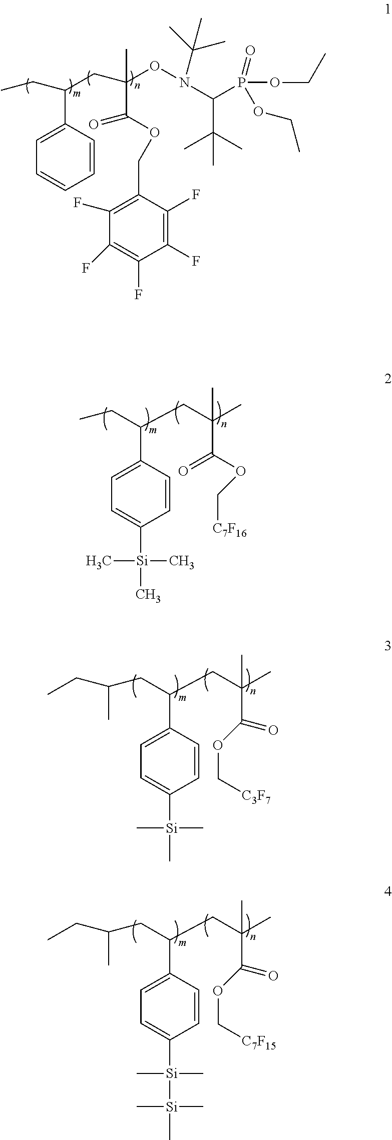

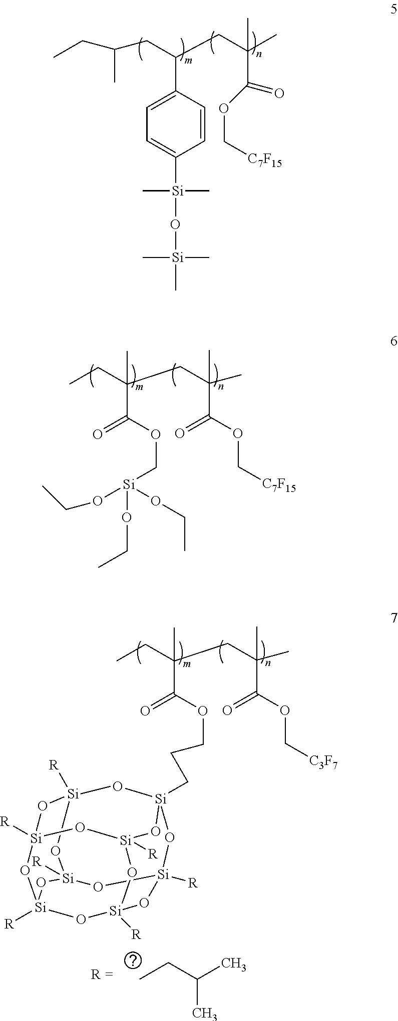

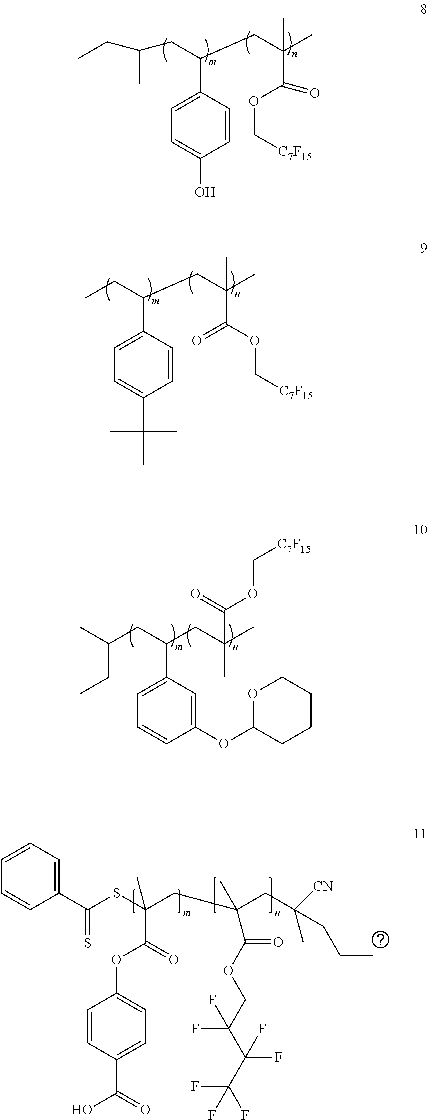

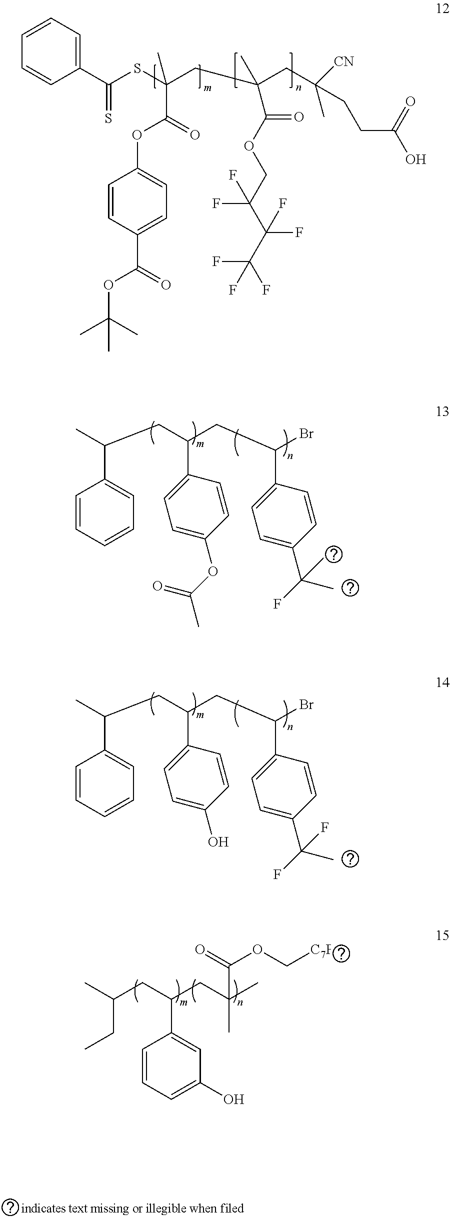

The present invention also provides a block polymer material comprising the block copolymer according to the first aspect of the present invention or prepared from the block copolymer according to the first aspect of the present invention.

Preferably, the block polymer material is selected from the group consisting of: a DSA-guided self-assembling material, a nanocatalyst, a functionalized nanoelectronic device, a portable precision storage material, and a biomedical nanodevice.

The present invention also provides a method for preparing the above block copolymer, comprising the steps of:

S1, selecting a monomer of block A and a monomer of block B, wherein the monomer of block A and the monomer of block B are selected from the monomers described above;

S2, polymerizing the monomer of block A to obtain block A, and polymerizing the monomer of block B in the presence of block A to obtain the block copolymer.

Preferably, the polymerization is achieved by anionic polymerization, nitroxyl radical polymerization, atom transfer radical polymerization (ATRP) or reversible addition fragmentation chain transfer polymerization (RAFT) reaction.

Preferably, in step S2, the molar ratio of block A to the monomer of block B for polymerization is 1-500:1-500; preferably, the molar ratio is 3-100:3-100; and more preferably, the molar ratio is 5-60:5-25.

Preferably, the preparation method may further include a step of deprotecting the compound obtained by polymerizing block A with the monomer of block B to obtain the block copolymer; and preferably, the deprotection is carried out by removal of the protection group via hydrolysis.

The present invention also provides an application in which the above block copolymer is applied to the preparation of a DSA-guided self-assembling material, a functionalized nanoelectronic device, a portable precision storage material, a biomedical nanodevice, an etching resistant material, a nanocatalytic material, a nano energy storage device or a nano biomedical carrier.

The present invention has the beneficial effects as described below. Compared with the prior art, the block copolymer of the structure of the present invention has an ultrahigh resolution of less than 5 nm; the fluorine and oxygen-containing block copolymer having ultrahigh resolution obtained by deprotecting the fluorine and oxygen-containing block copolymer precursor having ultrahigh resolution of the present invention can achieve ultrahigh resolution, excellent phase separation and rapid patterning at a lower annealing temperature (e.g., room temperature) and in a shorter annealing time (e.g., 30 s). For the copolymer of the embodiment of the present invention, there is a large difference in hydrophilcity and hydrophobicity between the chain segments, thus rapid self-assembly of highly ordered fluorine and oxygen-containing block copolymer materials having ultrahigh resolution can be realized in a short time under a low temperature or even room temperature, with potential self-repairing performance, such that, to a certain extent, it makes the assembled edge structure smoother, greatly reducing the defect rate of self-assembly. The block copolymer annealed at 160 degrees for 24 hours has no change in peak shape and the position in SAXS, and the phase separation can remain stable. The block copolymer of the embodiment of the present invention has higher etching contrast, and the monomers carry functional groups such as hydroxyl group or carboxyl group such that it is convenient for functional modification in the later stage. During its rapid assembly process, it has a certain degree of self-repairing performance, wherein one of the segments of the polymer can flow freely at room temperature, such that the assembly defect degree is greatly reduced, so as to be adapted for actual production application. The block copolymer of the embodiment of the present invention has higher etching contrast, and the monomer carries functional groups such as hydroxyl group or carboxyl group, etc., such that it is convenient for functional modification in the later stage. The block copolymer of the embodiment of the present invention can be built into a layered structure or a hexagonal phase structure by using different ratios of the two blocks; the preparation method thereof is simple, safe and low in cost, and a block copolymer having a smaller PDI can be prepared. Through introduction of silicon and other inorganic elements, the selectivity of etching can be improved. Through introduction of hydroxyl group, the hydrophilicity of one of the segments can be further increased, so that the phase separation size is smaller and the resolution is higher. In addition, hydroxyl group can also serve as a functionalization site and/or a crosslinking site.

### BRIEF DESCRIPTION OF THE DRAWINGS

FIG. 1 is a ¹H-NMR diagram of a block copolymer precursor prepared in Example 1 of the present invention;

FIG. 2 is a ¹H-NMR diagram of a block copolymer prepared in Example 1 of the present invention;

FIG. 3 is a DSC diagram of a block copolymer precursor prepared in Example 1 of the present invention;

FIG. 4 is a DSC diagram of a block copolymer prepared in Example 1 of the present invention;

FIG. 5 is an SAXS diagram of a block copolymer prepared in Example 1 of the present invention;

FIG. 6 is a water drop angle test diagram of a block copolymer prepared in Example 1 of the present invention;

FIG. 7 is a TEM diagram of a block copolymer prepared in Example 1 of the present invention assembled at room temperature;

FIG. 8 is a schematic chart showing the operational process of the low temperature rapid assembly quenching experiment of the embodiment of the present invention;

FIG. 9 is an SAXS diagram of a block copolymer prepared in Example 1 of the present invention after annealing;

FIG. 10 is a ¹H-NMR diagram of a product prepared in Example 2 of the present invention;

FIG. 11 is an SAXS diagram of a product prepared in Example 2 of the present invention after annealing;

FIG. 12 is a ¹H-NMR diagram of P4AS prepared in Example 3 of the present invention;

FIG. 13 is a ¹H-NMR diagram of a block copolymer prepared in Example 3 of the present invention before deprotection;

FIG. 14 is a ¹H-NMR diagram of a block copolymer prepared in Example 3 of the present invention before deprotection and after deprotection;

FIG. 15 is an SAXS diagram of a block copolymer prepared in Example 3 of the present invention;

FIG. 16 is a TEM diagram of the product of a block copolymer prepared in Example 3 of the present invention after assembling at room temperature;

FIG. 17 is a ¹H-NMR diagram of a block copolymer prepared in Example 4 of the present invention before deprotection;

FIG. 18 is a ¹H-NMR diagram of a block copolymer prepared in Example 4 of the present invention after deprotection;

FIG. 19 is a DSC diagram of a block copolymer prepared in Example 4 of the present invention after deprotection;

FIG. 20 is an SAXS diagram of a block copolymer prepared in Example 4 of the present invention after annealing;

FIG. 21 is a ¹H-NMR spectrum of the block copolymer PTMSS-b-PPDFMA-1;

FIG. 22 is a DSC diagram of the block copolymer PTMSS-b-PPDFMA-1;

FIG. 23 is an SAXS diagram of the block copolymer PTMSS-b-PPDFMA-1 obtained after quenching at a low temperature (80° C.) for a short time (5 min);

FIG. 24 is a ¹H-NMR spectrum of the block copolymer PTMSS-b-PHFBMA-1;

FIG. 25 is an SAXS diagram of the block copolymer PTMSS-b-PHFBMA-1 obtained after quenching at a low temperature (80° C.) for a short time (5 min);

FIG. 26 is a DSC diagram of the block copolymer PPMDS-b-PPDFMA-1;

FIG. 27 is an SAXS diagram of the block copolymer PPMDS-b-PPDFMA-1 obtained after quenching at a low temperature (80° C.) for a short time (5 min);

FIG. 28 is an SAXS diagram of PVPPMDS-b-PPDFMA-1 obtained after quenching at a low temperature (80° C.) for a short time (5 min);

FIG. 29 is a GPC diagram of the block copolymer PMMDA-b-PPDFMA-1;

FIG. 30 is an SAXS diagram of PMMDA-b-PPDFMA-1 obtained after quenching at a low temperature (80° C.) for a short time (5 min);

FIG. 31 is a GPC diagram of the block copolymer PHSQ-b-PHFBMA;

FIG. 32 is an SAXS diagram of the block copolymer PHSQ-b-PHFBMA after self-assembly;

FIG. 33 is a ¹H-NMR spectrum of the block copolymer PtBOS-b-PPDFMA;

FIG. 34 is a ¹H-NMR spectrum of the hydroxyl group containing block copolymer PHS-b-PPDFMA after hydrolysis;

FIG. 35 is an SAXS diagram of the block copolymer PtBOS-b-PPDFMA after self-assembly;

FIG. 36 is an SEM pattern of the guided self-assembly of the block copolymer in Example 5 after annealing in a silicon template; and

FIG. 37 is an SEM pattern of the guided self-assembly of the block copolymer in Example 6 after annealing in a silicon template.

### DETAILED DESCRIPTION OF THE EMBODIMENTS

The technical contents, the objects and effects of the present invention will be explained in detail in conjunction with the embodiments and the accompanying drawings below.

The inventors have obtained a block polymer material through long-term and in-depth research. In the block polymer material, the silicon and/or other inorganic elements introduced therein can improve the selectivity of etching, and the hydroxyl groups introduced therein can further increase the hydrophilicity of one of the segments, so that a smaller phase separation size and a higher resolution can be achieved, and the hydroxyl group can also serve as a functionalization site and/or a crosslinking site. The assembly defect degree of the block polymer material of the present invention can be greatly reduced, which lay a good foundation for selective etching in the later stage and for its practical application, so that the popularization and application of the nanoelectronic devices can be significantly promoted. On this basis, the inventors have completed the present invention.

Example 1 of the present invention is presented here. A block copolymer and a preparation method thereof are provided, wherein the block polymer is P3OTHPS-b-PPDFMA-1 prepared by an anionic polymerization method.

3 ml of 3OTHPS

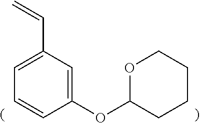

was dissolved in 35 mL of tetrahydrofuran. Dibutylmagnesium solution (1M in n-hexane) was added and the temperature was raised to 40° C. for reaction for 0.5 h. The treated mixture was transferred to the reaction flask. The temperature of the reaction flask was allowed to return to room temperature, and the mixture was stirred uniformly, then the flask was placed in a −80° C. cold bath and cooled for 15 min. 0.65 mL of sec-BuLi (1.3 M in n-hexane) was added and kept at −80° C. for reaction for 15 min. The temperature of the dried fluorine-containing methacrylate

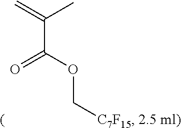

was lowered to −60° C., and then it was added dropwise into the reaction system, and maintained at −80° C. for reaction for 40 min. The product was precipitated in ethanol to give a white solid (4.5 g).

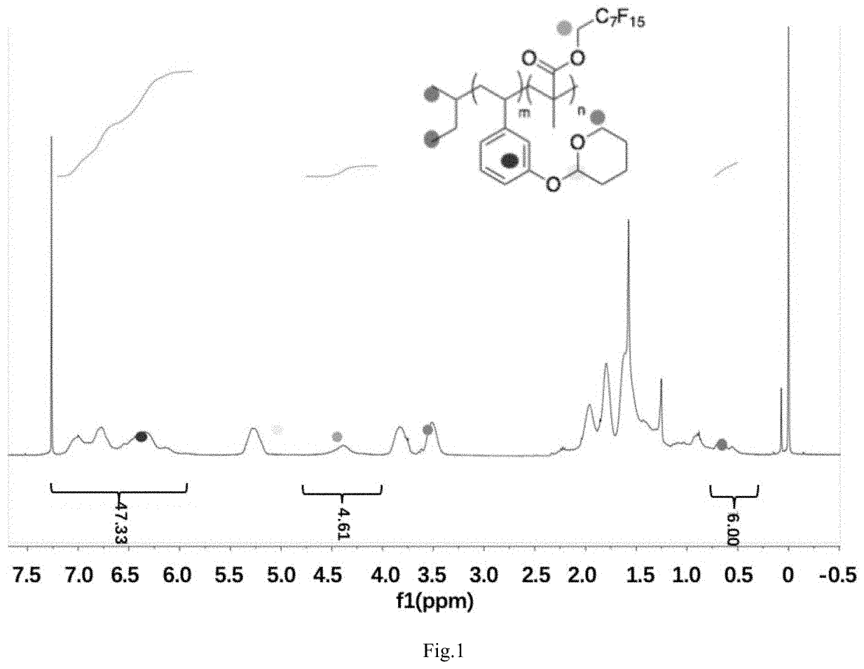

The white precipitate prepared by the above operations was analyzed by ¹H Nuclear Magnetic Resonance Spectroscopy (¹H-NMR). The results were as shown in FIG. 1. It can be seen from FIG. 1 that the characteristic H peaks of the block P3OTHPS and the block PPDFMA correspond to the structure as shown, and the integral areas are also consistent with the feed ratio of the two homopolymeric monomers.

The white solid obtained in the above operations was measured for molecular weight via gel permeation chromatography (GPC), and upon the analysis of GPC, the fluorine and oxygen-containing block copolymer P3OTHPS-b-PPDFMA-1 with ultrahigh resolution obtained in Example 1 had a number average molecular weight of 19,176 and a PDI of 1.13.

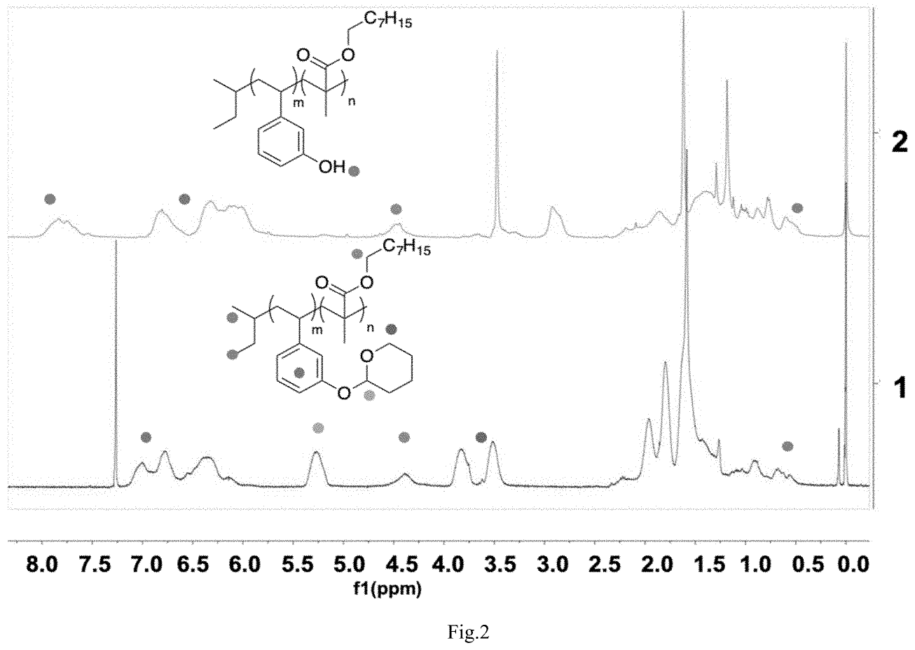

The hydroxyl group in P3OTHPS-b-PPDFMA-1 prepared by the above operations was exposed by chemical deprotection to obtain PHS-b-PPDFMA, and the results of ¹H-NMR analysis were as shown in FIG. 2. The reaction equation for the chemical deprotection operation was as follows:

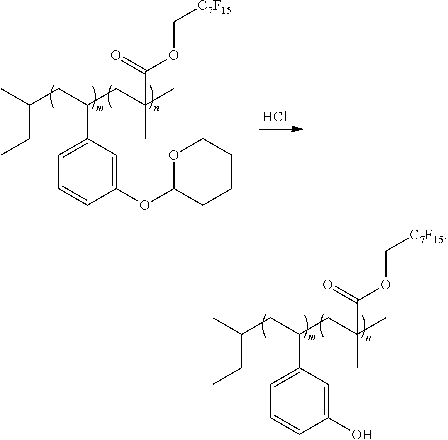

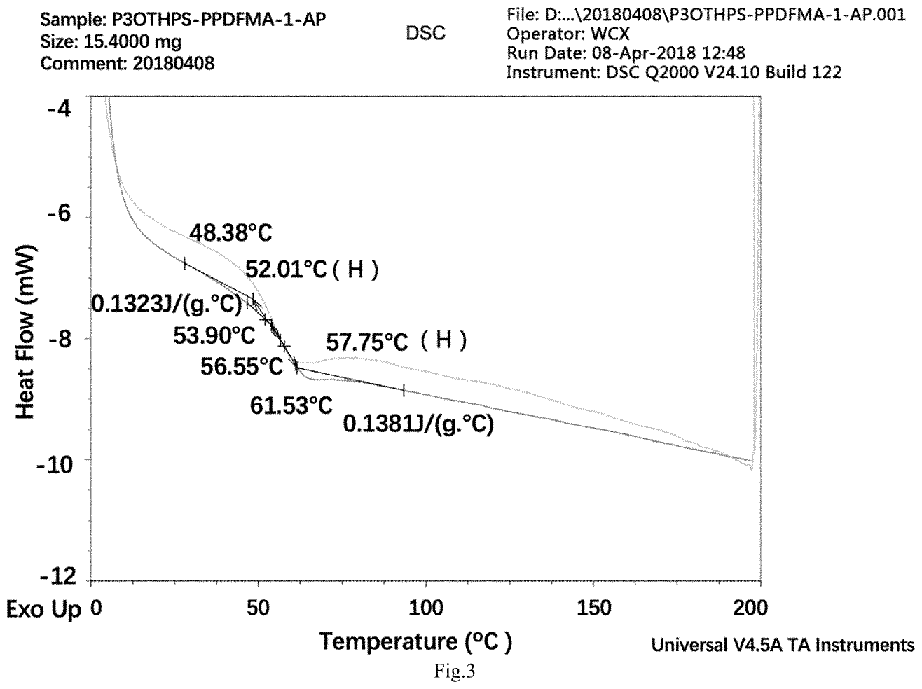

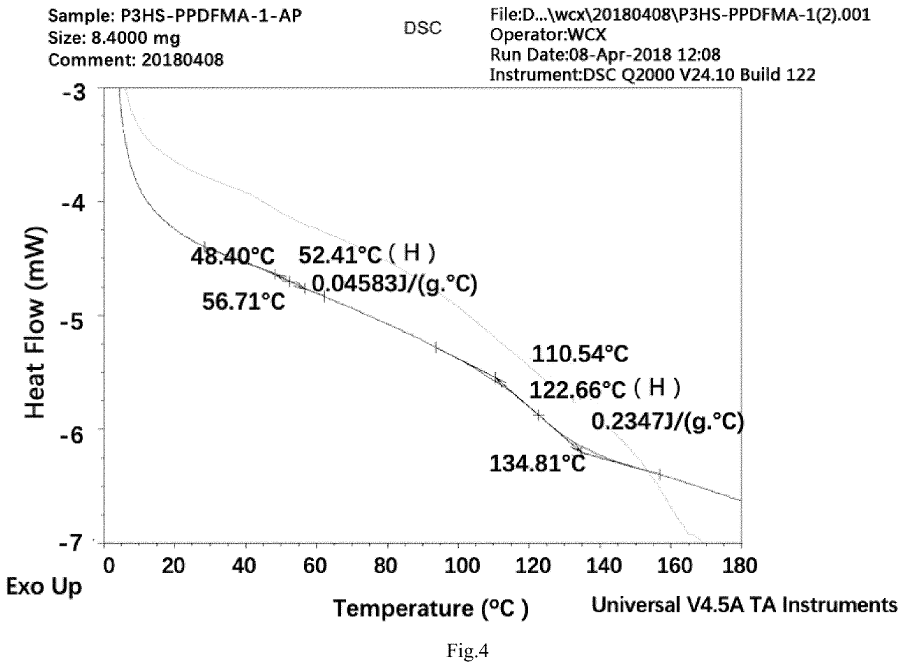

The differential scanning calorimetry (DSC) diagrams of P3OTHPS-b-PPDFMA-1 before and after deprotection were as shown in FIGS. 3 and 4, respectively.

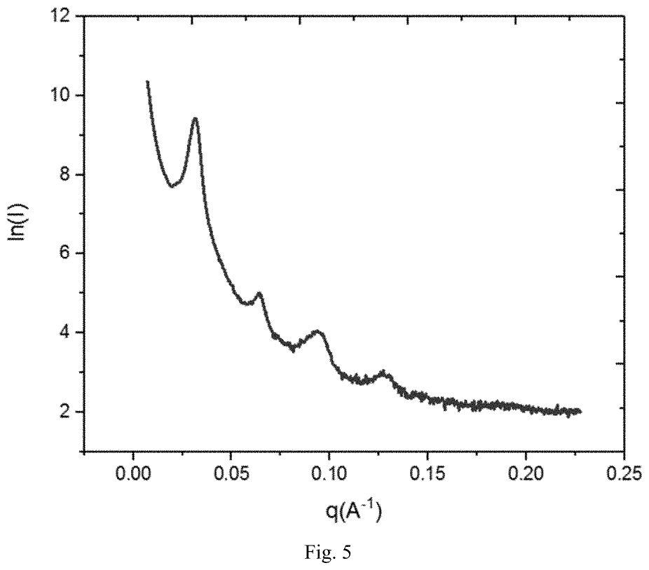

The small-angle X-ray scattering (SAXS) obtained for the copolymer after quenching at a low temperature for a short time showed a structure with a full-pitch of 18.9 nm, that is, a half-pitch of 9.4 nm, after assembling, as shown in FIG. 5.

A series of experimental studies with different molar ratios of monomers of the two blocks in the feed were carried out. The corresponding characterization results were shown in Table 1 below.

TABLE 1
Characterization of physical properties of products prepared
with different molar ratios in the feed

| Molar ratio | Mn (NMR) | M/N | GPC (A) | full-pitch |
|---|---|---|---|---|
| 3:1 | 12465 | 43/8 | 19176 | 18.9 nm (LAM) |
| 3:2 | 18300 | 61/12 | 17314 | 18.7 nm ((LAM)) |
| 3:7 | 14200 | 46/10 | 13375 | 17.5 nm (LAM) |
| 3:8 | 13920 | 42/9 | 13958 | 16.6 nm (LAM) |
| 3:10 | 4023 | 7/5 | 4667 | disorder |
| 3:11 | 7644 | 26/5 | 8102 | 9.8 nm (LAM) |

As can be seen from Table 1, the fluorine and oxygen-containing block copolymer having ultrahigh resolution prepared by the embodiment of the present invention can achieve a high resolution of less than 5 nm.

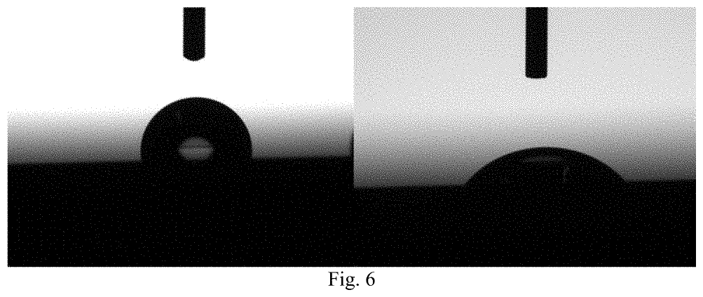

The hydrophilicity or hydrophobicity of the above deprotected fluorine and oxygen-containing block copolymer having ultrahigh resolution were tested by a water drop angle tester. The results were shown in FIG. 6. It can be seen from FIG. 6 that the two blocks are greatly different in hydrophilcity or hydrophobicity. The left picture shows the test results of PPDFMA having a water drop angle of 99°; and the right picture shows the test results of 4-hydroxystyrene (poly(4-hydroxystyrene) (PHS)) having a water drop angle of 45°.

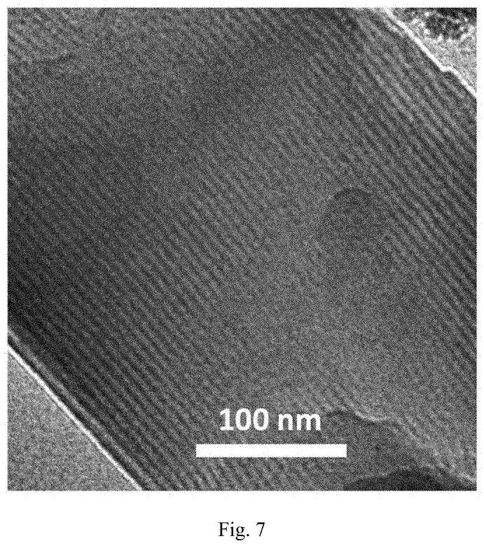

When calculated with Hildebrand solubility parameters, PPDFMA had a solubility parameter of 11.9 (J/cm³)^{1/2}, and styrene (Polystyrene, PS), polymethylmethacrylate (PMMA), polydimethylsiloxane (PDMS), polyvinylpyridine (poly(2-vinylpyridine), P2VP) had a solubility parameter of 18.5, 19.0, 15.5 and 20.6 (J/cm³)^{1/2}, respectively, and PHS had a solubility parameter of 24.55 (J/cm³)^{1/2}. Therefore, compared with commonly used polymers, the two blocks were greatly different in respect of the hydrophilcity or hydrophobicity. Due to the large difference in hydrophilicity or hydrophobicity between the two chain segments, the microstructure of the material after assembling at room temperature was observed under a Transmission Electron Microscope (abbreviated as TEM). The results were as shown in FIG. 7. As can be seen from FIG. 7, the block copolymer with structure of the present invention can have a regular pattern after assembling at room temperature.

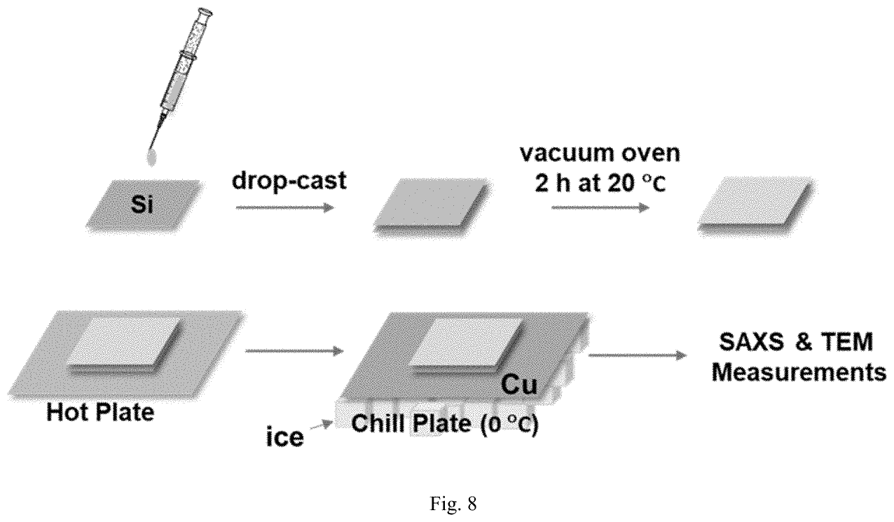

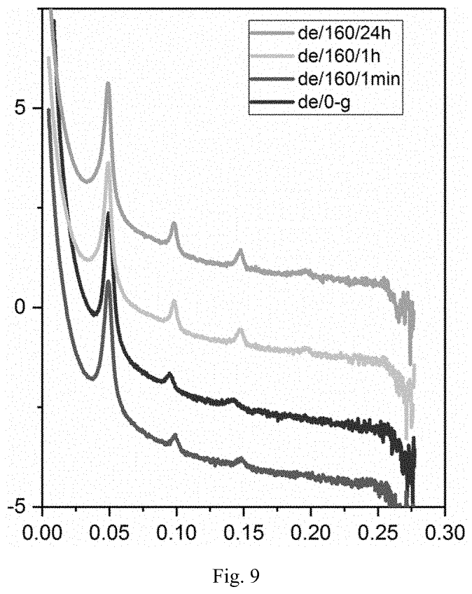

As shown in FIG. 8, in order to confirm the structure and size of the phase separation assembly formed by the polymer assembly, the dried polymer PHS-b-PPDFMA was dissolved in tetrahydrofuran or toluene, and then drop-casted onto a silicon chip, heated on a hot plate (e.g., 160° C.), and removed at a certain time (e.g., 1 min), and cooled (e.g., 0° C.) with a chill plate (for 24 h, for example). The obtained sample (e.g., a bulk solid thin film having a thickness of 30-50 μm or a powder) was subjected to later measurement of SAXS, and the SAXS diagram of the sample after annealing at 160° C. was as shown in FIG. 9. In FIG. 9, the SAXS diagrams from top to bottom are diagrams of fluorine and oxygen-containing block copolymers having ultrahigh resolution after annealing for 24 hours, annealing for 1 hour, annealing for 1 minute and without annealing, respectively. It can be seen from FIG. 9 that after annealing at 160° C. for 24 hours, no change is shown in the peak shape and the position in SAXS, and the phase separation can still remain stable.

Example 2 of the present invention is presented here. A block copolymer, a preparation method and an application thereof are provided, wherein the block copolymer is a halogen-substituted benzyl methacrylate block polymer (block polymer 1), and the route for synthesis thereof is as follows:

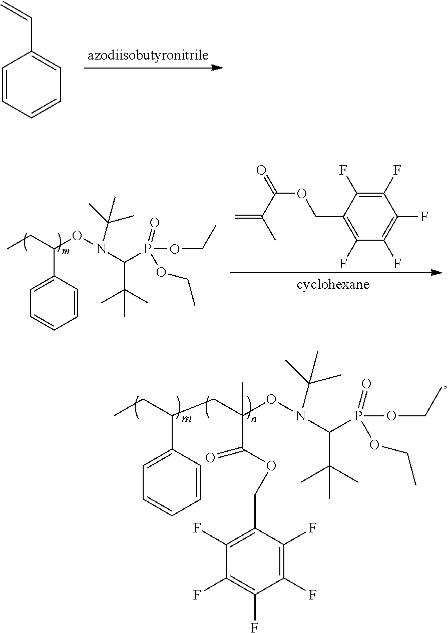

wherein, nitrogen-tert-butyl-1-diethyl phosphate-2,2-dimethylpropyl nitroxide (DEPN) was used as a nitroxyl radical for the styrene moiety, and azobisisobutyronitrile (in an amount of 0.01-0.02 fold of the monomer in mole) initiated the polymerization of styrene (1.5-3 ml of styrene monomer), followed by addition of a second segment of a fluorine-containing benzyl-substituted methacrylate monomer (1.5-2 ml) into the system, so that the polymerization reaction was allowed to be carried out at 120° C. for 24 h. The reaction crude product was washed several times with methanol, and then dried in a vacuum oven to obtain a block polymer 1.

The structure of the obtained block polymer 1 was:

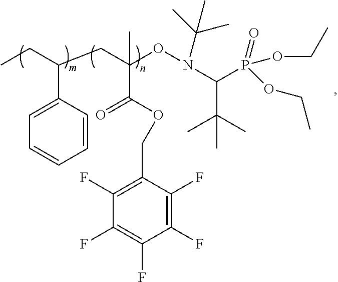

### i.e., PS-b-PPFBMA.

For block polymers PS-b-PPFBMA-1-4, the two monomers had different ratios in feed.

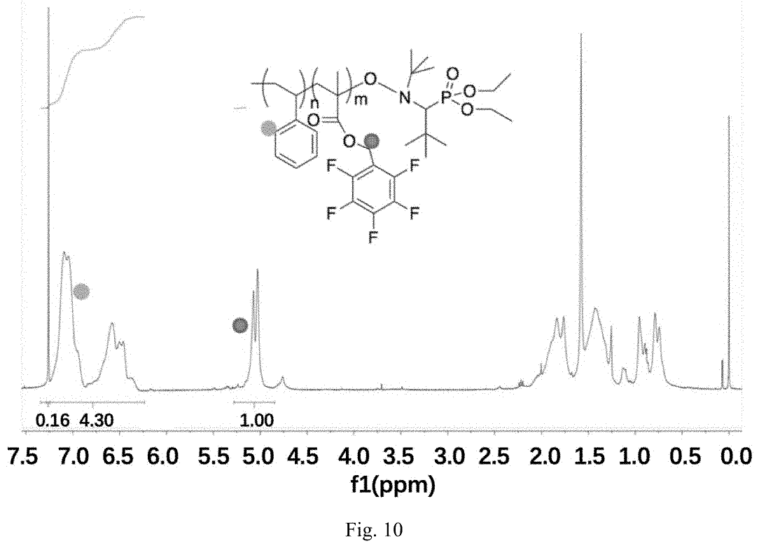

The NMR spectrum of the obtained PS-b-PPFBMA-4 was: ¹H NMR (400 MHz, CDCl₃, δ): 7.25-6.27 (5H; Ar—H), 5.26-4.78 (2H; OCH₂), as shown in FIG. 10.

It can be seen from FIG. 10 that the characteristic H peaks of the block PS and the block PPFBMA correspond to the structure as shown, and the integral areas are also consistent with the feed ratio of the two block monomers.

After analysis by GPC and the like, the number average molecular weight and molecular weight distribution of the four block copolymers were shown in Table 2 below.

TABLE 2
Characterization data table of PS-b-PPFBMA
block copolymers in Example 2

| | Number | | | |
|---|---|---|---|---|
| | average | | Molecular | |
| | molecular | | weight | Assembly size |
| | weight | | distribution | (Morphology, |
| Name of Polymer | [Kg mol⁻¹] | m/n | (i.e., PDI) | SAXS results) |
| PS-b-PPFBMA-1 | 5100 | 11.0 | 1.14 | Disorder |
| PS-b-PPFBMA-2 | 4900 | 6.0 | 1.12 | Disorder |
| PS-b-PPFBMA-3 | 5200 | 3.4 | 1.15 | Disorder |
| PS-b-PPFBMA-4 | 17000 | 1.7 | 1.31 | 28 nm |
| | | | | (Hexagonal |
| | | | | phase) |

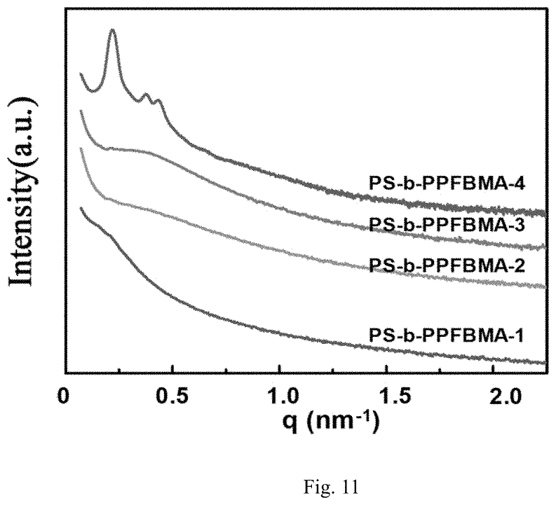

The SAXS diagrams of the self-assembled products of the block copolymers PS-b-PPFBMA (1-4) after heat quenching (temperature of 160° C., time of 10 h) was as shown in FIG. 11.

It can be seen from FIG. 11 that PS-b-PPFBMA-1˜3 cannot form an ordered assembly structure due to insufficient phase separation driving force, and the self-assembly of PS-b-PPFBMA-4 reached a full-pitch of 28 nm, and its assembled structure was in a hexagonal phase.

For related etch contrast measurement, the changes in film thickness of homopolymers of the two components under the CF₄ plasma etching (herein, taking the etching gas CF₄ as an example, the gas flow rate was 30 sccm, and the power was 30 W) had significant difference, wherein the film thickness of the PS polystyrene (original film thickness was 200 nm) was reduced by 45 nm after 1 minute of etching, and the film thickness of the PPFBMA (original film thickness was 250 nm) was reduced by 80 nm after 1 minute of etching. It can be seen that the styrene component had a stronger etching resistance than the fluorine-containing acrylate component.

Example 3 of the present invention is presented here. A block copolymer, a preparation method and an application thereof are provided, wherein the block copolymer is P4AS-b-PTFMS, and the reaction equation for the preparation process thereof is as follows:

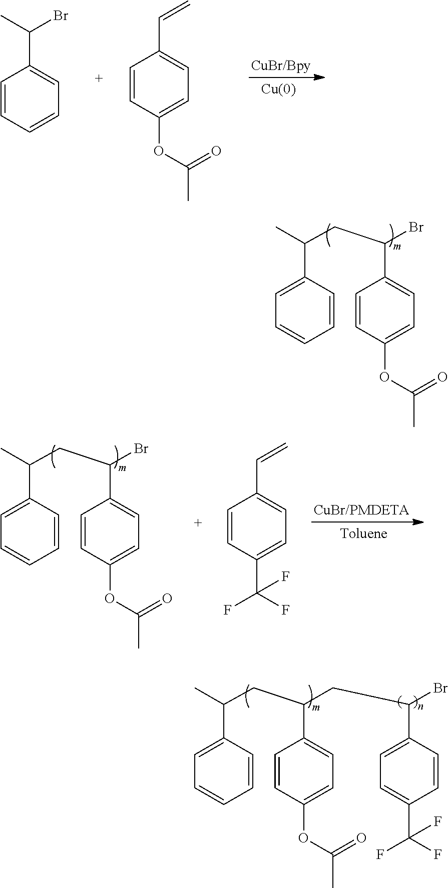

The above-mentioned fluorine and oxygen-containing block copolymer having ultrahigh resolution was synthesized by the ATRP method, firstly by using

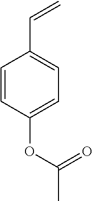

to synthesize a macromolecular initiator

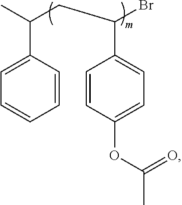

and then using the macromolecular initiator to initiate

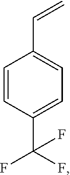

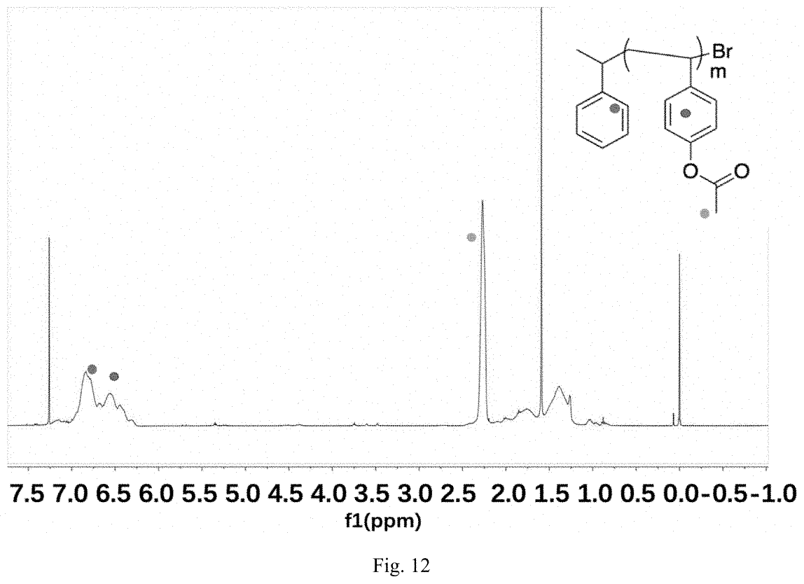

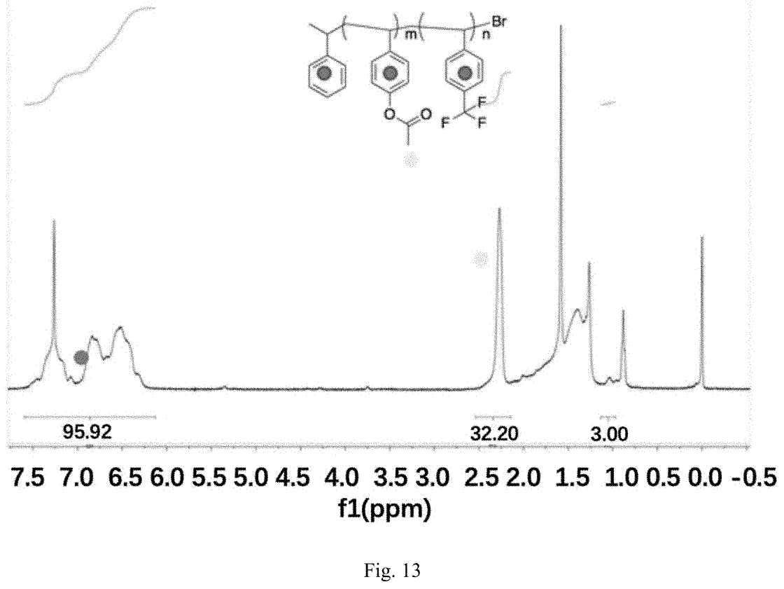

thereby preparing the fluorine and oxygen-containing block copolymer having ultrahigh resolution. The characterization test by NMR spectrum was performed for P4AS and P4AS-b-PTFMS respectively. The test results were shown in FIGS. 12 and 13. At the same time, the GPC test was performed for the prepared P4AS-b-PTFMS, and the test results showed that the molecular weight was 7936 and the PDI was 1.07.

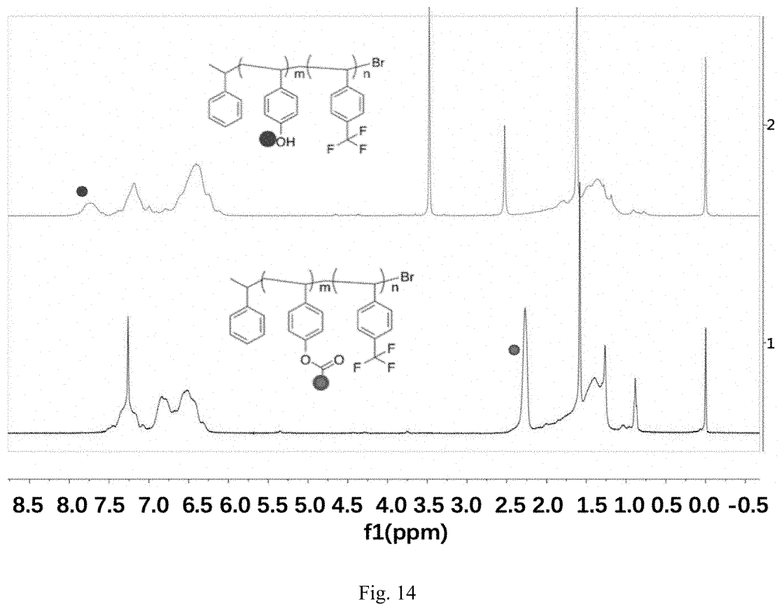

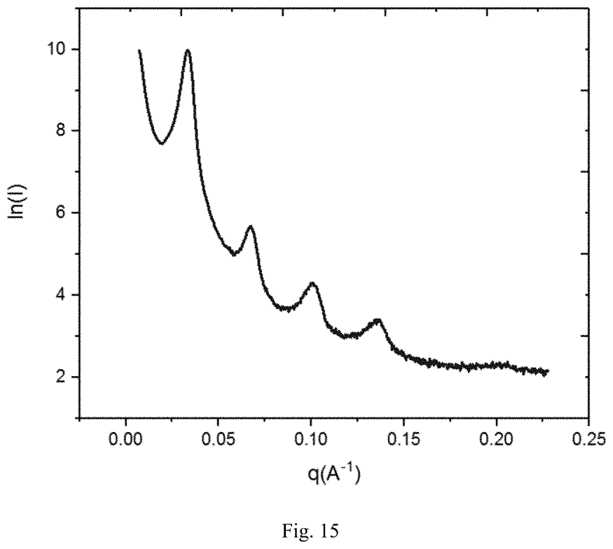

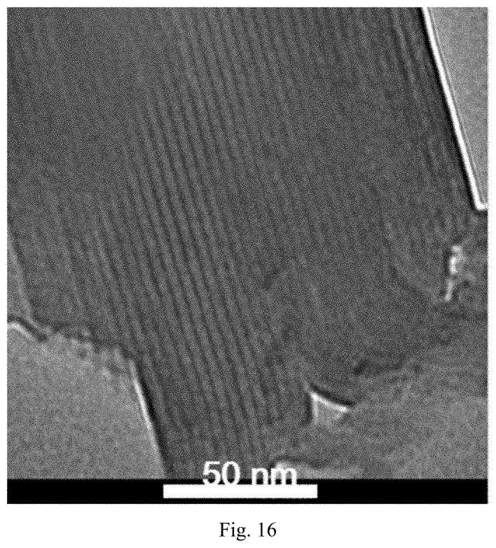

The P4AS-b-PTFMS prepared by the above operations was deprotected by chemical deprotection. The nuclear magnetic resonance spectra of the block copolymer before and after deprotection were as shown in FIG. 14. After deprotection, it was quenched at 80° C. for 1 minute, then the SAXS characterization was performed, as shown in FIG. 15, wherein the full-pitch obtained after assembly was 18.5 nm, that is, the half-pitch was 9.2 nm. The TEM diagram of the product obtained by assembling of the block copolymer at room temperature was as shown in FIG. 16.

Example 4 of the present invention is presented here. A block copolymer, a preparation method and an application thereof are provided, wherein the block copolymer is PBMMA-b-F3MA, and the reaction equation for the preparation process thereof is as follows:

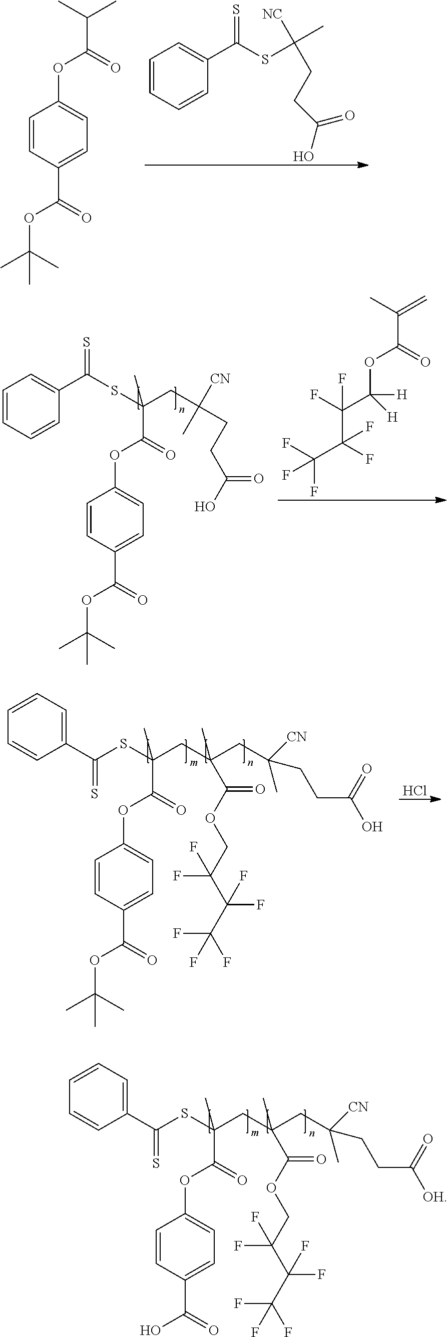

The reversible addition-fragmentation chain transfer polymerization (RAFT) method was used for the polymerization preparation, firstly by using

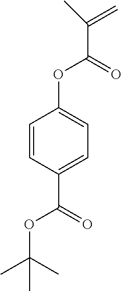 [SMILES: C=C(C)C(=O)Oc1ccc(C(=O)OC(C)(C)C)cc1]

to synthesize a macromolecular initiator

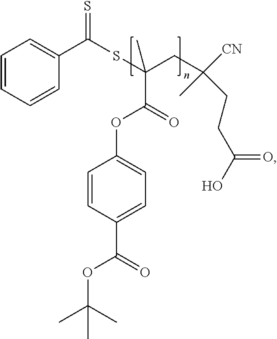

and then using the macromolecular initiator to initiate

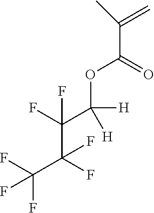 [SMILES: C=C(C)C(=O)OCC(F)(F)C(F)(F)C(F)(F)F]

to prepare a block copolymer, and finally deprotecting the block copolymer under acidic conditions to obtain

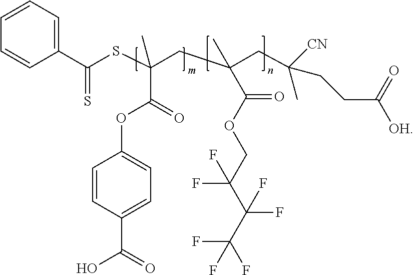

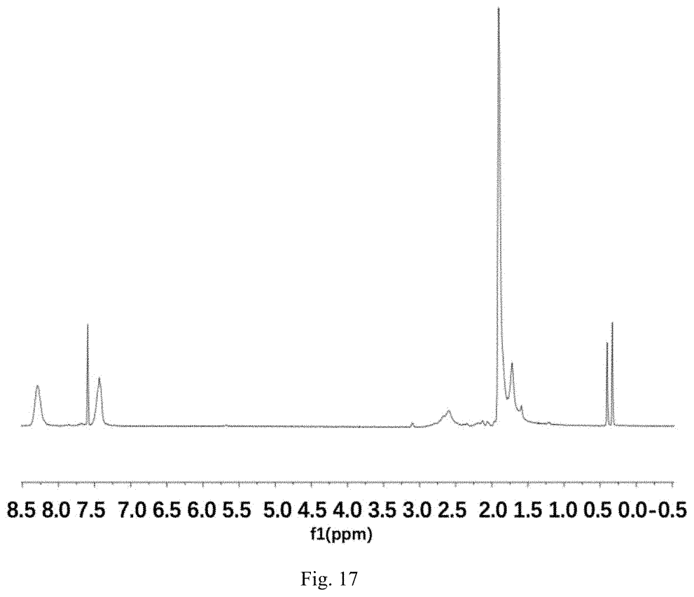

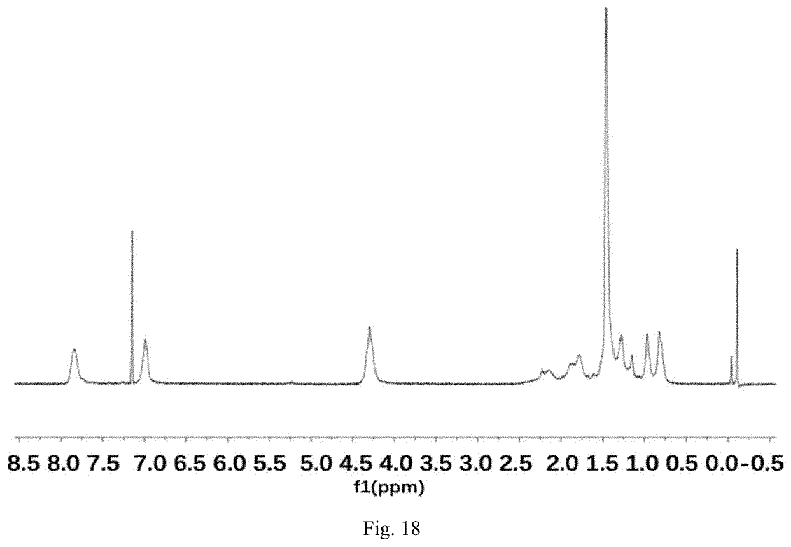

The nuclear magnetic characterizations were performed for PBMMA-b-F3MA before and after deprotection, and the results were as shown in FIGS. 17 and 18.

GPC showed that the molecular weight of PBMMA-b-F3MA was 17917, and the PDI was 1.14.

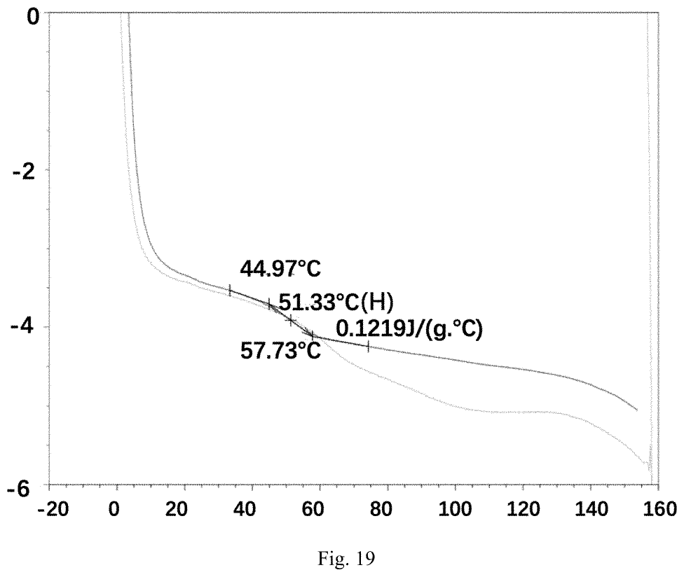

The DSC diagram of PBMMA-b-F3MA after deprotection was as shown in FIG. 19.

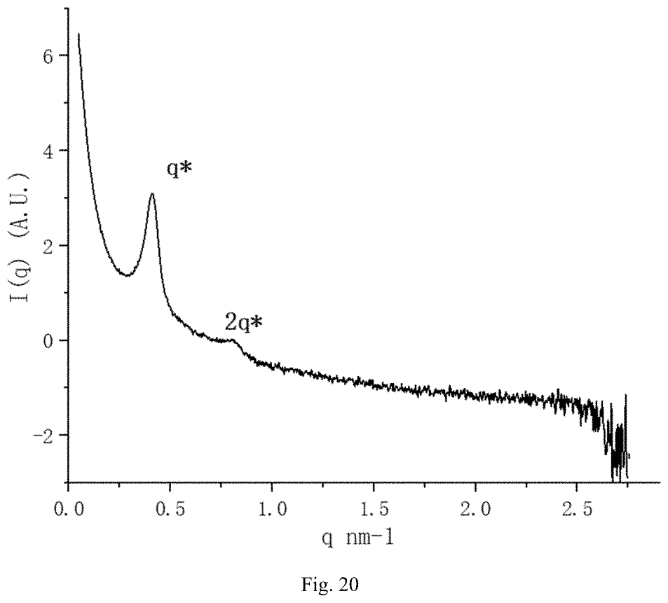

The SAXS diagram obtained by annealing PBMMA-b-F3MA at 80° C. for 1 minute showed a structure with a full-pitch of 15.4 nm after assembly, that is, a half-pitch of 7.7 nm, as shown in FIG. 20 specifically.

Example 5 of the present invention is: synthesis and assembly of PTMSS-b-PPDFMA block polymers (block polymer 2)

2-3 mL of silane group-substituted styrene

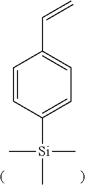

and 30-35 mL of tetrahydrofuran were treated with dibutylmagnesium solution (1M in n-hexane) at 40° C. for 0.5 h, and transferred to the reaction flask. The temperature of the reaction flask was allowed to return to room temperature, the mixture was stirred uniformly, and then the flask was placed in a −80° C. cold bath and cooled for 15 min 05-0.65 mL of sec-BuLi (1.3 M in n-hexane) was added and the flask was kept at −80° C. for reaction for 15 min. The temperature of the dried fluorine-containing methacrylate monomer

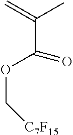

(1.5-2.5 ml) was lowered to −60° C., added dropwise into the reaction system, and maintained at −80° C. for reaction for 40 min. The product was precipitated in ethanol to give a white solid (3.5-4.5 g).

The structure of the obtained block polymer 2 was

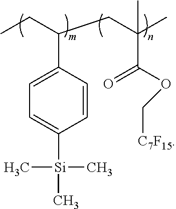

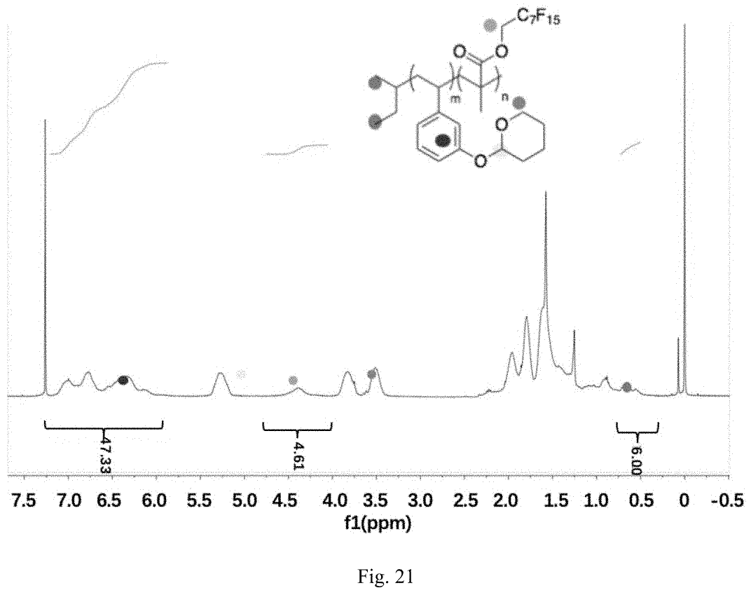

FIG. 21 is ¹H-NMR spectrum of the block copolymer PTMSS-b-PPDFMA-1.

It can be seen from FIG. 21 that the characteristic H peaks of the block PTMSS and the block PPDFMA correspond to the structure as shown, and the integral areas are also consistent with the feed ratio of the two block monomers.

Upon GPC analysis, the block copolymer PTMSS-b-PPDFMA-1 has a number average molecular weight of 5800 and a PDI of 1.13.

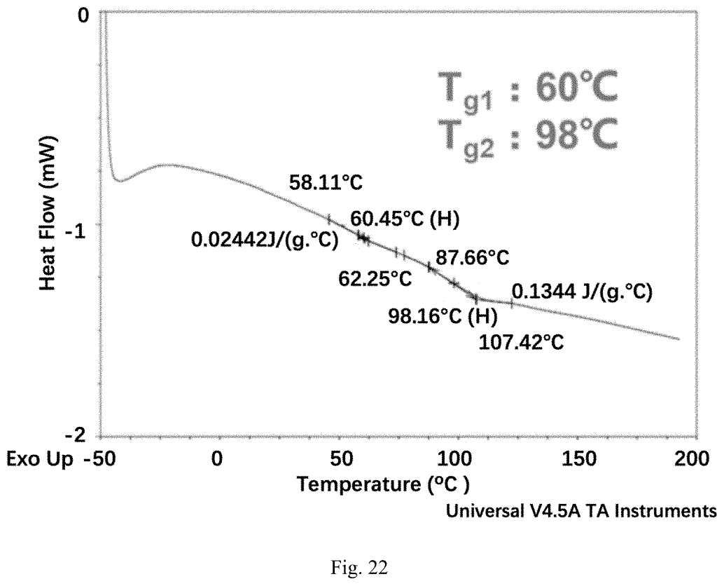

FIG. 22 is the DSC diagram of the block copolymer PTMSS-b-PPDFMA-1.

It can be seen from FIG. 22 that in the second heating cycle, the glass transition temperatures were 60° C. and 98° C., respectively.

In order to confirm the structure and size of the phase separation assembly formed by the polymer assembly, the dried polymer PTMSS-b-PPDFMA-1˜5 was dissolved in tetrahydrofuran or toluene, and then drop-casted onto a silicon chip, heated on a hot plate, and removed at a certain time, cooled with a chill plate. The resulting sample was subjected to measurement of SAXS later.

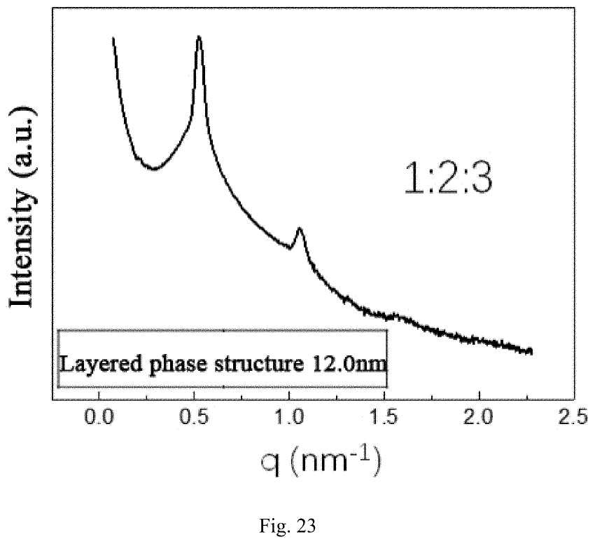

FIG. 23 is the SAXS diagram of the block copolymer PTMSS-b-PPDFMA-1 obtained after quenching at a low temperature (80° C.) for a short time (5 min).

It can be seen from FIG. 23 that after assembly, a structure with a full-pitch of 12 nm was obtained, that is, the half-pitch was 6 nm.

When the feed ratio of the two components was improved, we can obtain the block polymers PTMSS-b-PPDFMA-2˜5. The characterization method was similar to one with the above PTMSS-b-PPDFMA-1, and the characterization results were shown in Table 3 below.

TABLE 3
The characterization results of the polymers obtained
with different feed ratios in Example 5

| | Number | | | |
|---|---|---|---|---|
| | average | | Molecular | |
| | molecular | | weight | Assembly |
| | weight | | distribution | size |
| Name of Polymer | [kg mol⁻¹] | m/n | (PDI) | (Morphology) |
| PTMSS-b-PPDFMA-1 | 5800 | 3.7 | 1.13 | 12.0 nm |
| | | | | Layered |
| PTMSS-b-PPDFMA-2 | 4500 | 2.6 | 1.15 | 10.3 nm |
| | | | | Layered |
| PTMSS-b-PPDFMA-3 | 3800 | 1.4 | 1.14 | 9.5 nm |
| | | | | Hexagonal |
| | | | | prism |
| PTMSS-b-PPDFMA-4 | 6200 | 4.2 | 1.16 | 13.3 nm |
| | | | | Layered |
| PTMSS-b-PPDFMA-5 | 6800 | 4.5 | 1.15 | 14.3 nm |
| | | | | Layered |

Since the component containing inorganic Si atoms has stronger etching resistance in dry etching than the purely organic component, the etching contrast between the PTMSS component and the PPDFMA component was greatly enhanced due to the introduction of Si atoms (compared to the etching contrast of polymers formed from polystyrene and PPDFMA without addition of Si).

Specifically, the changes in film thickness of the homopolymers of the two component under the oxygen plasma etching (herein, taking the etching gas oxygen as an example, the gas flow rate was 50 sccm, and the power was 30 W) were significantly different, wherein the film thickness of the PTMSS homopolymer (original film thickness was 250 nm) was reduced by 10 nm after 1 minute of etching, while the film thickness of the PS polystyrene (original film thickness was 230 nm) was reduced by 65 nm after 1 minute of etching, and the film thickness of the PPDFMA (original film thickness was 260 nm) was reduced by 90 nm after 1 minute of etching. It can be seen that the introduction of Si significantly increased the etching contrast.

Example 6 of the present invention is: synthesis and assembly of PTMSS-b-PHFBMA block polymers (block polymer 3)

2-3 mL of silane group-substituted styrene

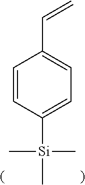

and 30-35 mL of tetrahydrofuran were treated with dibutylmagnesium solution (1M in n-hexane) at 35° C. for 0.5 h, and transferred to the reaction flask. The temperature of the reaction flask was allowed to return to room temperature, and the mixture was stirred uniformly, then the flask was placed in a −80° C. cold bath and cooled for 15 min. 0.5-0.6 mL of sec-BuLi (1.3 M in n-hexane) was added and the flask was kept at −80° C. for reaction for 15 min. The temperature of the dried fluorine-containing methacrylate monomer

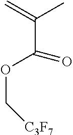

(1.5-2.5 ml) was lowered to −60° C., added dropwise into the reaction system, and maintained at −80° C. for reaction for 40 min. The product was precipitated in ethanol to give a white solid (3.5-4.5 g).

The structure of the obtained block polymer 3 was

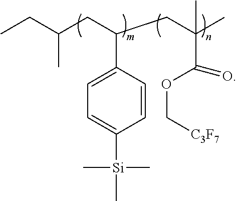

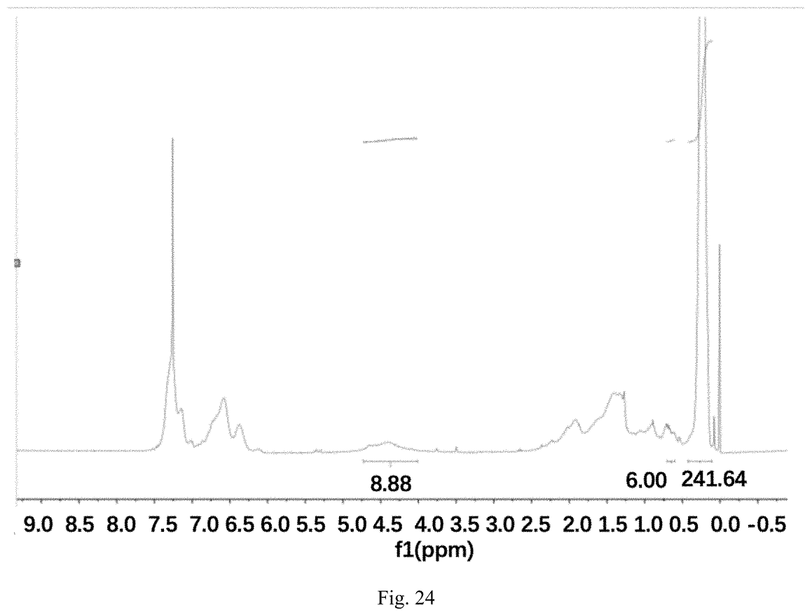

FIG. 24 is ¹H-NMR spectrum of the block copolymer PTMSS-b-PHFBMA-1.

It can be seen from FIG. 24 that the characteristic H peaks of the block PTMSS and the block PHFBMA correspond to the structure as shown, and the integral areas are also consistent with the feed ratio of the two block monomers.

Upon GPC analysis, the block copolymer PTMSS-b-PHFBMA-1 has a number average molecular weight of 5400 and a PDI of 1.14.

In order to confirm the structure and size of the phase separation assembly formed by the polymer assembly, the dried polymer PTMSS-b-PHFBMA-1˜4 was dissolved in tetrahydrofuran or toluene, and then drop-casted onto a silicon chip, heated on a hot plate, and removed at a certain time, cooled with a chill plate. The resulting sample was subjected to measurement of SAXS later.

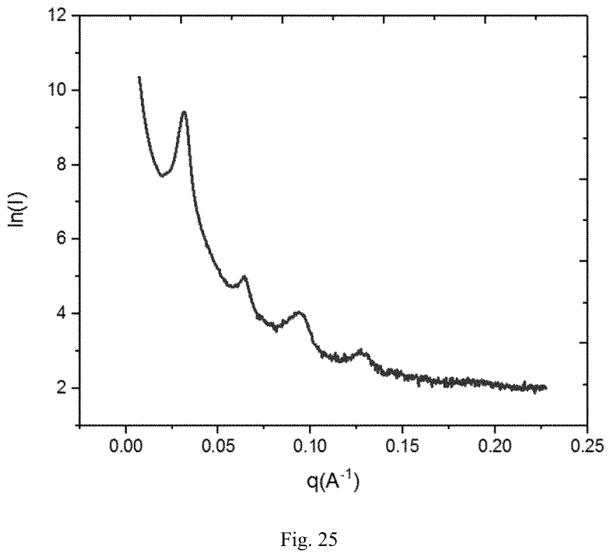

FIG. 25 is the SAXS diagram of the block copolymer PTMSS-b-PHFBMA-1 obtained after quenching at a low temperature (80° C.) for a short time (5 min).

It can be seen from FIG. 25 that after assembly of the block copolymer PTMSS-b-PHFBMA-1, a structure with a full-pitch of 12.4 nm was obtained, that is, the half-pitch was 6.2 nm.

When the feed molar ratio of the two components was improved, we can obtain the block polymers PTMSS-b-PHFBMA-2˜4. The characterization method was similar to the one with the above PTMSS-b-PHFBMA-1, and the characterization results were shown in Table 4 below.

TABLE 4
Characterization results of polymers with different
feed molar ratios in Example 6.

| | Number | | | |
|---|---|---|---|---|
| | average | | Molecular | |
| | molecular | | weight | Assembly |
| | weight | | distribution | size |
| Name of Polymer | [kg mol⁻¹] | m/n | (PDI) | (Morphology) |
| PTMSS-b-PHFBMA-1 | 5400 | 2.5 | 1.14 | 12.4 nm |
| | | | | Layered |
| PTMSS-b-PHFBMA-2 | 4700 | 2.2 | 1.15 | 11.2 nm |
| | | | | Layered |
| PTMSS-b-PHFBMA-3 | 4200 | 1.9 | 1.14 | 10.0 nm |
| | | | | Layered |
| PTMSS-b-PHFBMA-4 | 6000 | 3.2 | 1.16 | 13.8 nm |
| | | | | Layered |

Since the component containing inorganic Si atoms has stronger etching resistance in dry etching than the purely organic component, the etching contrast between the PTMSS component and the PHFBMA component was greatly enhanced due to the introduction of Si atoms (compared to the etching contrast between the polystyrene component without addition of Si and the PHFBMA component).

Specifically, the changes in film thickness of the homopolymers of the two components under the oxygen plasma etching (herein, taking the etching gas oxygen as an example, the gas flow rate was 50 sccm, and the power was 30 W) had significant difference, wherein the film thickness of the PTMSS homopolymer (original film thickness was 250 nm) was reduced by 10 nm after 1 minute of etching, while the film thickness of the PS polystyrene (original film thickness was 230 nm) was reduced by 65 nm after 1 minute of etching, and the film thickness of the PHFBMA (original film thickness was 200 nm) was reduced by 100 nm after 1 minute of etching. It can be seen that the introduction of Si significantly increased the etching contrast.

Example 7 of the present invention is: synthesis and assembly of PPMDS-b-PPDFMA block polymers (block polymer 4)

2-3 mL of silane group-substituted styrene

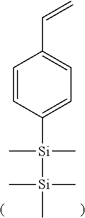

and 30-35 mL of tetrahydrofuran were treated with dibutylmagnesium solution (1M in n-hexane) at 35° C. for 0.5 h, and transferred to the reaction flask. The temperature of the reaction flask was allowed to return to room temperature, and the mixture was stirred uniformly, then the flask was placed in a −80° C. cold bath and cooled for 15 min. 0.5-0.6 mL of sec-BuLi (1.3 M in n-hexane) was added and kept at −80° C. for reaction for 15 min. The temperature of the dried fluorine-containing methacrylate monomer

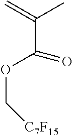

(1.5-2.5 ml) was lowered to −60° C., added dropwise into the reaction system, and maintained at −80° C. for reaction for 40 min. The product was precipitated in ethanol to give a white solid (3.5-4.5 g).

The structure of the obtained block polymer 4 was

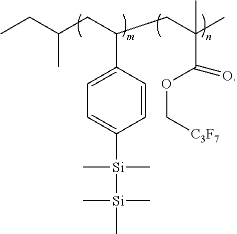

Upon GPC analysis, the block copolymer PPMDS-b-PPDFMA-1 has a number average molecular weight of 4200 and a PDI of 1.15.

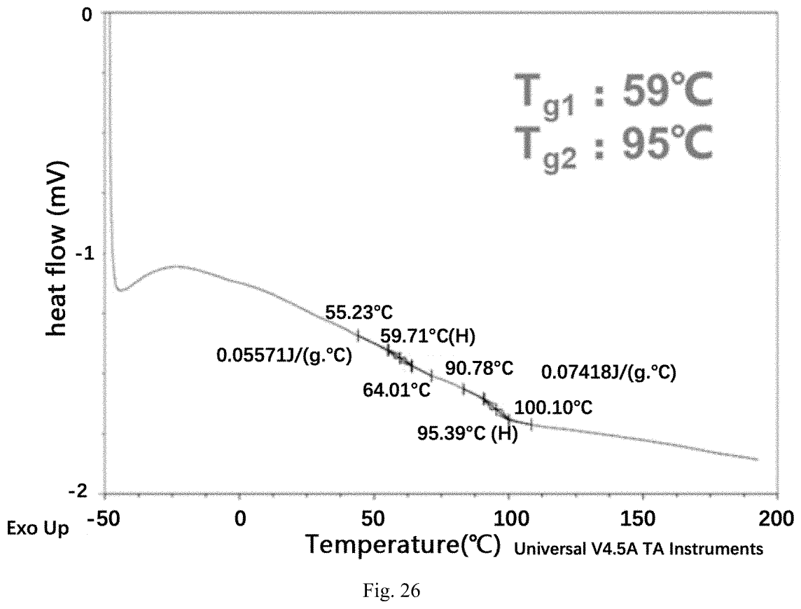

FIG. 26 is the DSC diagram of the block copolymer PPMDS-b-PPDFMA-1.

It can be seen from FIG. 26 that in the second heating cycle, the glass transition temperatures of the block copolymer PPMDS-b-PPDFMA-1 were 59° C. and 95° C., respectively.

In order to confirm the structure and size of the phase separation assembly formed by the polymer assembly, the dried polymer PPMDS-b-PPDFMA-1˜3 was dissolved in tetrahydrofuran or toluene, and then drop-casted onto a silicon chip, heated on a hot plate (e.g., 80° C.), and removed at a certain time (e.g., 5 min), cooled (e.g., 0° C.) with a chill plate (for 5 min, for example). The resulting sample (e.g., a bulk solid film having a thickness of 30-50 μm or a powder) was used for measurement of SAXS later.

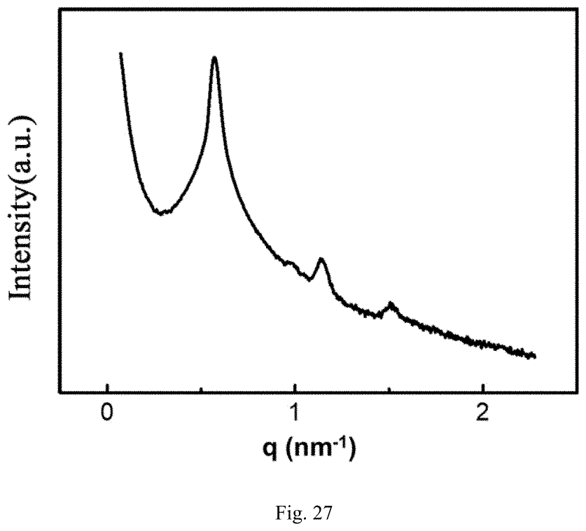

FIG. 27 is the SAXS diagram of the block copolymer PPMDS-b-PPDFMA-1 obtained after quenching at a low temperature (80° C.) for a short time (5 min).

It can be seen from FIG. 27 that after assembly of the block copolymer PPMDS-b-PPDFMA-1, a structure with a full-pitch of 10.6 nm was obtained, that is, the half-pitch was 5.3 nm.

When the feed molar ratio of the two components was improved, we can obtain the block polymers PPMDS-b-PPDFMA-2˜3. The characterization method was similar to the one with the above PPMDS-b-PPDFMA-1, and the characterization results were shown in Table 5 below.

TABLE 5
Characterization results of PPMDS-b-PPDFMA
polymers prepared in Example 7

| | | | Molecular | |
|---|---|---|---|---|
| | Number average | | weight | Assembly |
| Name of | molecular weight | | distribution | size |
| Polymer | [kg mol⁻¹] | m/n | (PDI) | (Morphology) |
| PPMDS-b- | 4200 | 1.3 | 1.15 | 10.6 nm |
| PPDFMA-1 | | | | Layered |
| PPMDS-b- | 4800 | 1.8 | 1.14 | 11.5 nm |
| PPDFMA-2 | | | | Layered |
| PPMDS-b- | 6400 | 2.5 | 1.16 | 13.9 nm |
| PPDFMA-3 | | | | Layered |

Since the component containing inorganic Si atoms has stronger etching resistance in dry etching than the purely organic component, the monomer PPMDS in this example comprised two Si atoms, and the etching contrast thereof was greatly enhanced compared with the PTMSS in Example 5. The changes in film thickness of the homopolymers of the two components under the oxygen plasma etching (the gas flow rate was 50 sccm, and the power was 30 W) had significant difference, wherein the film thickness of the PTMSS (original film thickness was 260 nm) was reduced by 10 nm after 1 minute of etching, the film thickness of the PPMDS (original film thickness was 280 nm) was reduced by 7 nm after 1 minute of etching, the film thickness of the PS polystyrene (original film thickness was 230 nm) was reduced by 65 nm after 1 minute of etching, and the film thickness of PPDFMA (original film thickness was 260 nm) was reduced by 90 nm after 1 minute of etching. It can be seen that the introduction of multiple Si increases the etching resistance of the homopolymer compared to the introduction of a single Si, that is, increases the etching contrast between the homopolymer and the fluorine-containing acrylate polymer.

Example 8 of the present invention is: synthesis and assembly of PVPPMDS-b-PPDFMA block polymers (block polymer 5)

2-3 mL of silane group-substituted styrene

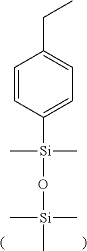

and 30-35 mL of tetrahydrofuran were treated with dibutylmagnesium solution (1M in n-hexane) at 35° C. for 0.5 h, and transferred to the reaction flask. The temperature of the reaction flask was allowed to return to room temperature, and the mixture was stirred uniformly, then the flask was placed in a −85° C. cold bath and cooled for 15 min. 0.5-0.6 mL of sec-BuLi (1.3 M in n-hexane) was added and kept at −85° C. for reaction for 15 min. The temperature of the dried fluorine-containing methacrylate monomer

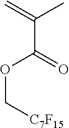

(1.5-2 ml) was lowered to −50° C., added dropwise into the reaction system, and maintained at −85° C. for reaction for 40 min. The product was precipitated in ethanol to give a white solid (3.5-4 g).

The structure of the obtained block polymer 5 was

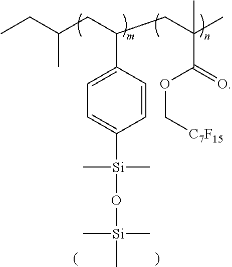

Upon GPC analysis, the block copolymer PVPPMDS-b-PPDFMA-1 has a number average molecular weight of 6300 and a PDI of 1.14.

In order to confirm the structure and size of the phase separation assembly formed by the polymer assembly, the dried polymer PVPPMDS-b-PPDFMA-1 was dissolved in tetrahydrofuran or toluene, and then drop-casted onto a silicon chip, heated on a hot plate (e.g., 80° C.), and removed at a certain time (e.g., 5 min), cooled with a chill plate (e.g., 0° C.) (for 5 min, for example). The resulting sample (e.g., a bulk solid film having a thickness of 30-50 μm or a powder) was used for measurement of SAXS later.

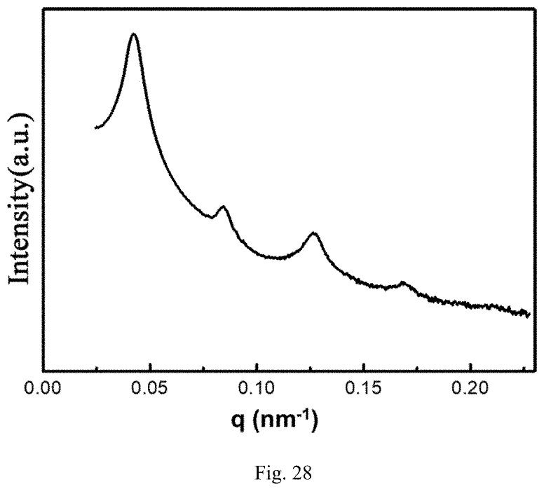

FIG. 28 is the SAXS diagram of PVPPMDS-b-PPDFMA-1 obtained after quenching at a low temperature (80° C.) for a short time (5 min).

It can be seen from FIG. 28 that after assembly of the block copolymer PVPPMDS-b-PPDFMA-1, a structure with a full-pitch of 14.5 nm was obtained, that is, the half-pitch was 7.3 nm.

In the etching performance test, the changes in film thickness of the homopolymers of the two components under the oxygen plasma etching (herein, taking the etching gas oxygen as an example, the gas flow rate was 50 sccm, and the power was 30 W) had significant difference, wherein the film thickness of the PVPPMDS homopolymer (original film thickness was 200 nm) was reduced by 18 nm after 1 minute of etching, while the film thickness of the PPDFMA (original film thickness was 260 nm) was reduced by 90 nm after 1 minute of etching. It can be seen that the introduction of Si significantly increased the etching contrast.

Example 9 of the present invention is: synthesis and assembly of PMMDA-b-PPDFMA block polymers (block polymer 6):

The synthesis of the polymer was carried out by ATRP polymerization method, and the first block

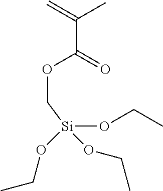 [SMILES: C=C(C)C(=O)OC[Si](OCC)(OCC)OCC]

was initiated by MBriB/EtBriB or tBBrP to generate a macromolecular initiator, followed by initiation of the ATRP reaction of the fluorine-containing methacrylate monomer

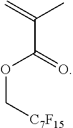

The feed ratio of the two monomers in the reaction was 3:1-2:1.

The structure of the obtained block polymer 6 was:

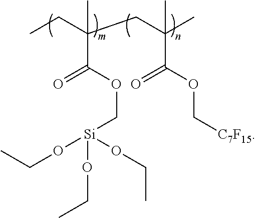

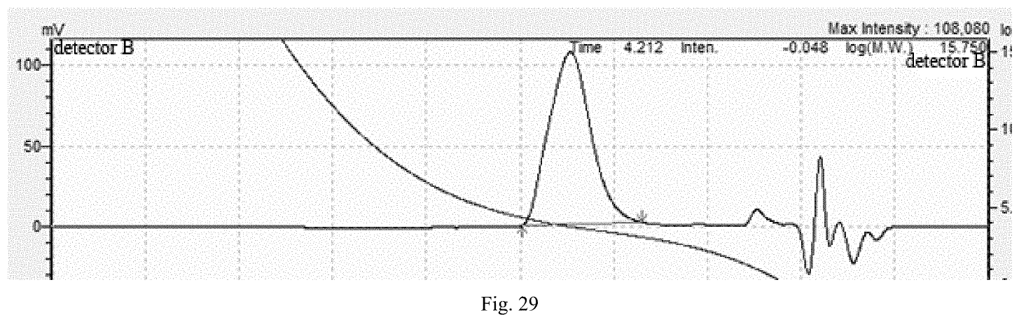

FIG. 29 is the GPC diagram of the block copolymer PMMDA-b-PPDFMA-1.

As can be seen from FIG. 29, PMMDA-b-PPDFMA-1 had a number average molecular weight of 5700, and a PDI of 1.22.

In order to confirm the structure and size of the phase separation assembly formed by the polymer assembly, the dried polymer PMMDA-b-PPDFMA-1 was dissolved in tetrahydrofuran or toluene, and then drop-casted onto a silicon chip, heated on a hot plate (e.g., 80° C.), and removed at a certain time (e.g., 5 min), cooled with a chill plate (e.g., 0° C.) (for 5 min, for example). The resulting sample (e.g., a bulk solid film having a thickness of 30-50 μm or a powder) was used for measurement of SAXS later.

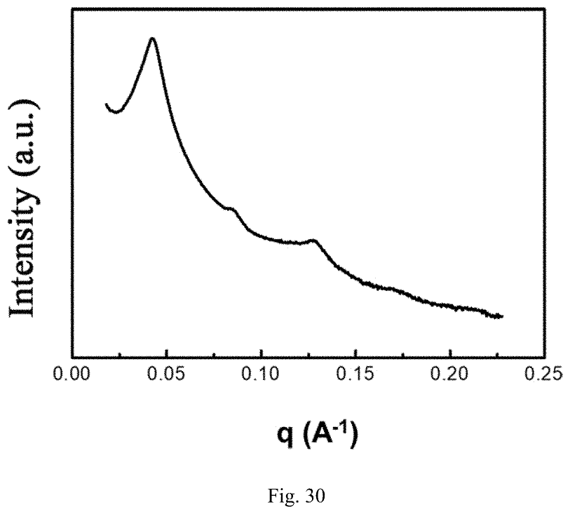

FIG. 30 is the SAXS diagram of PMMDA-b-PPDFMA-1 obtained after quenching at a low temperature (80° C.) for a short time (5 min).

It can be seen from FIG. 30 that after assembly of the PMMDA-b-PPDFMA-1, a layered structure with a full-pitch of 14.2 nm was obtained, that is, the half-pitch was 7.1 nm.

In the etching performance test, the changes in film thickness of homopolymers of the two components under the oxygen plasma etching (herein, taking the etching gas oxygen as an example, the gas flow rate was 50 sccm, and the power was 30 W) had significant difference, wherein the film thickness of the PMMDA homopolymer (original film thickness was 270 nm) was reduced by 35 nm after 1 minute of etching, while the film thickness of the PPDFMA (original film thickness was 260 nm) was reduced by 90 nm after 1 minute of etching. It can be seen that the introduction of Si significantly increased the etching contrast.

Example 10 of the present invention is: the synthesis and assembly of the PHSQ-b-PHFBMA block polymers (block polymer 7). The synthesis of the block polymer adopts the ATRP polymerization method. The specific implementation method was the same as that in the Example 9. The two monomers used were caged siloxane-substituted methacrylate monomer

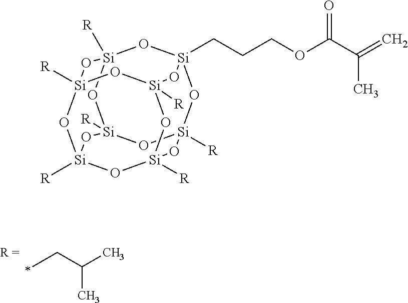

and fluorine-containing acrylate monomer

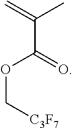

The monomers were dried and treated to exclude polymerization inhibitor in advance, and the reaction was carried out for polymerization at 75° C. for 16 hours.

The structure of the obtained block polymer 7 was:

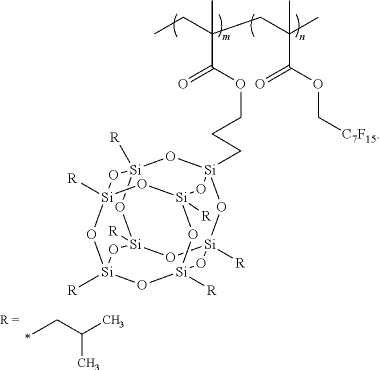

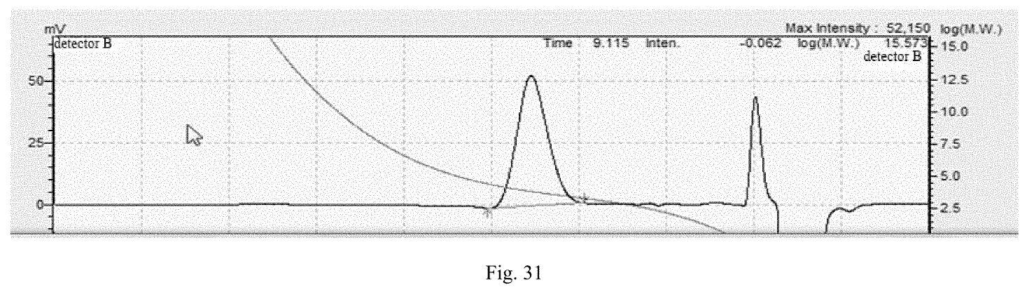

FIG. 31 is the GPC diagram of the block copolymer PHSQ-b-PHFBMA.

As can be seen from FIG. 31, the block copolymer PHSQ-b-PHFBMA had a number average molecular weight of 6500, and a PDI of 1.17.

In order to confirm the structure and size of the phase separation assembly formed by the polymer assembly, the dried polymer PHSQ-b-PHFBMA was dissolved in tetrahydrofuran or toluene, and then drop-casted onto a silicon chip, heated on a hot plate, and removed at a certain time, cooled with a chill plate. The resulting sample was used for measurement of SAXS later.

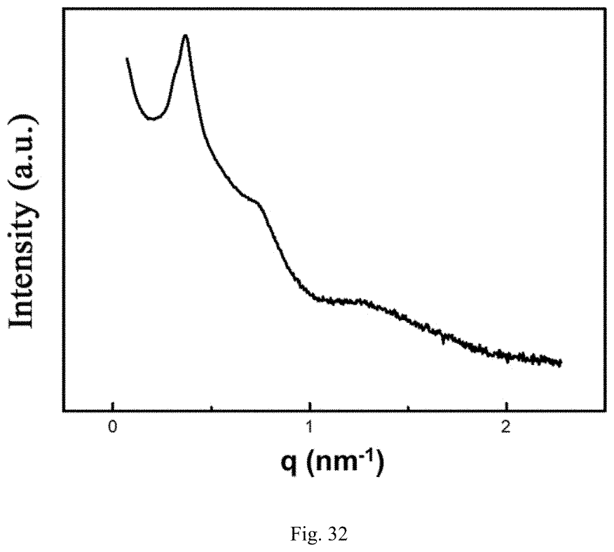

FIG. 32 is the SAXS diagram of the block copolymer PHSQ-b-PHFBMA after self-assembly.

As can be seen from FIG. 32, the assembled size of the block copolymer PHSQ-b-PHFBMA was 16.9 nm, that is, the half-pitch was 8.5 nm.

In the etching performance test, the changes in film thickness of the homopolymers of the two components under the oxygen plasma etching (herein, taking the etching gas oxygen as an example, the gas flow rate was 50 sccm, and the power was 30 W) had significant difference, wherein the film thickness of the PHSQ homopolymer (original film thickness was 170 nm) was reduced by 10 nm after 1 minute of etching, while the film thickness of the PHFBMA (original film thickness was 200 nm) was reduced by 100 nm after 1 minute of etching. It can be seen that the introduction of Si significantly increased the etching contrast.

Example 11 of the present invention is: synthesis and assembly of PHS-b-PPDFMA block polymers (block polymer 8):

2-3 mL of tert-butoxyl-substituted styrene

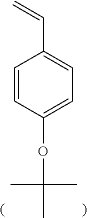

and 30-35 mL of tetrahydrofuran were treated with dibutylmagnesium solution (1M in n-hexane) at 40° C. for 0.5 h, and transferred to the reaction flask. The temperature of the reaction flask was allowed to return to room temperature, and the mixture was stirred uniformly, then the flask was placed in a −80° C. cold bath and cooled for 15 min. 0.5-0.6 mL of sec-BuLi (1.3 M in n-hexane) was added and kept at −80° C. for reaction for 15 min. The temperature of the dried fluorine-containing methacrylate monomer

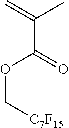

(1.5-2.5 ml) was lowered to −60° C., added dropwise into the reaction system, and maintained at −80° C. for reaction for 40 min. The product was precipitated in ethanol to give a white solid (3.7-4.6 g).

The obtained block polymer 8 had a structural formula of

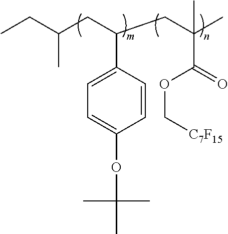

(PtBOS-b-PPDFMA), followed by hydrolysis of the tert-butoxyl group in the polymer with trifluoroacetic acid to obtain a hydroxyl group-containing block copolymer

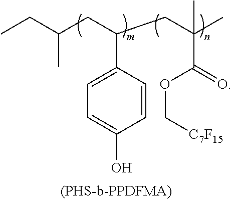

In addition, for the meta-hydroxyl group, a monomer

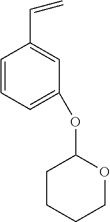

and a fluorine-containing acrylate monomer

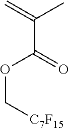

may be used, followed by hydrolysis of the first block with trifluoroacetic acid to form a

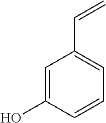

containing block polymer.

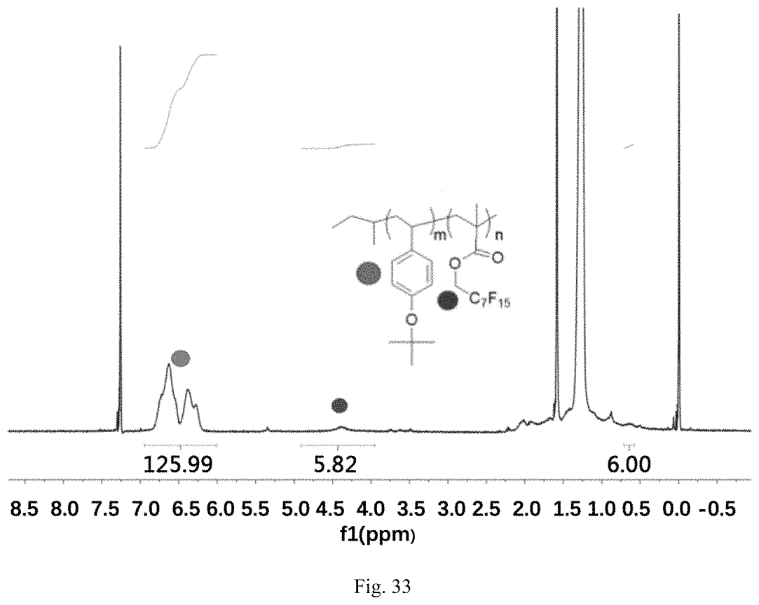

FIG. 33 is the ¹H-NMR spectrum of the block copolymer PtBOS-b-PPDFMA.

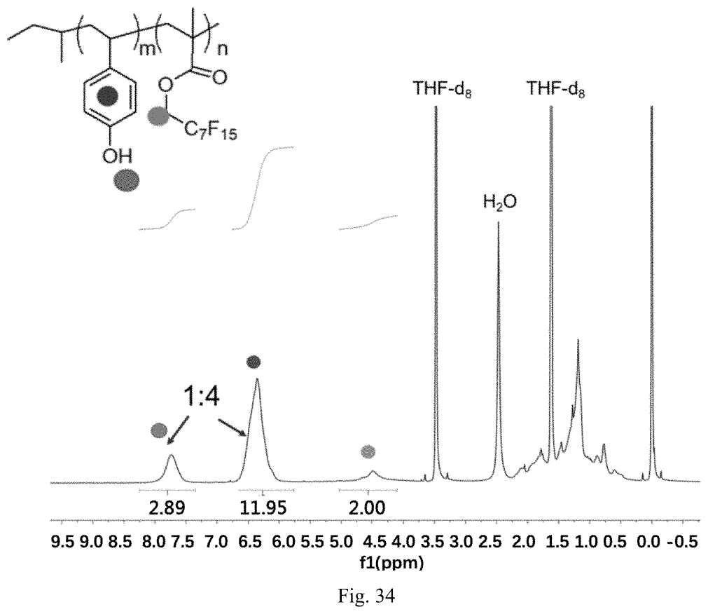

FIG. 34 is the ¹H-NMR spectrum of the hydroxyl group containing block copolymer PHS-b-PPDFMA after hydrolysis.

Upon GPC analysis, the block copolymer PtBOS-b-PPDFMA had a number average molecular weight of 11000 and a PDI of 1.10. The block copolymer PHS-b-PPDFMA had a number average molecular weight of 10000 and a PDI of 1.10.

In order to confirm the structure and size of the phase separation assembly formed by the polymer assembly, the dried polymer PtBOS-b-PPDFMA was dissolved in tetrahydrofuran or toluene, and then drop-casted onto a silicon chip, heated on a hot plate, and removed at a certain time, cooled with a chill plate. The resulting sample was used for measurement of SAXS later.

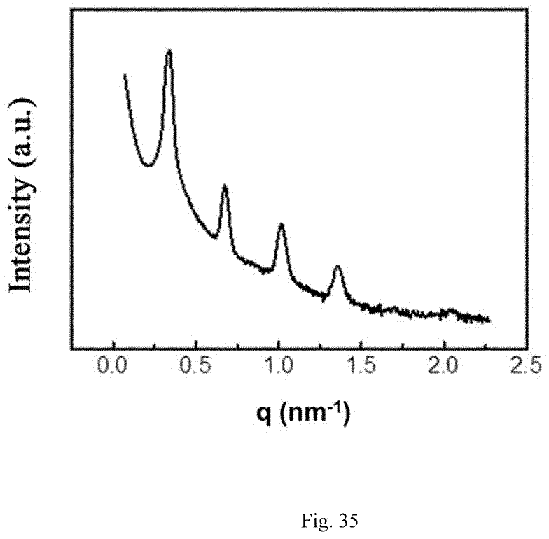

FIG. 35 is the SAXS diagram of the block copolymer PtBOS-b-PPDFMA after self-assembly.

As can be seen from FIG. 35, the assembly size of the block copolymer PtBOS-b-PPDFMA was 18.5 nm in full-pitch, that is, the half-pitch was 9.3 nm.

In the etching performance test, the changes in film thickness of the homopolymers of the two components under the oxygen plasma etching (herein, taking the etching gas oxygen as an example, the gas flow rate was 50 sccm, and the power was 30 W) had significant difference, wherein the film thickness of the PtBOS homopolymer film (original film thickness was 180 nm) was reduced by 45 nm after 1 minute of etching, while the film thickness of the PPDFMA (original film thickness was 260 nm) was reduced by 90 nm after 1 minute of etching.

Example 12 of the present invention is: synthesis and assembly of PtBS-b-PPDFMA block polymers (block polymer 9):

2-3 mL of tert-butyl-substituted styrene

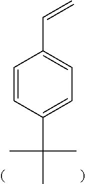

and 30-35 mL of tetrahydrofuran were treated with dibutylmagnesium solution (1M in n-hexane) at 40° C. for 0.5 h, and transferred to the reaction flask. The temperature of the reaction flask was allowed to return to room temperature, and the mixture was stirred uniformly, then the flask was placed in a −80° C. cold bath and cooled for 15 min 0.5-0.6 mL of sec-BuLi (1.3 M in n-hexane) was added and kept at −80° C. for reaction for 15 min. The temperature of the dried fluorine-containing methacrylate monomer

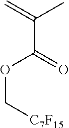

(1.5-2 ml) was lowered to −60° C., added dropwise into the reaction system, and maintained at −80° C. for reaction for 40 min. The product was precipitated in ethanol to give a white solid (3.5-4.5 g).

The structure of the obtained block polymer 9 was:

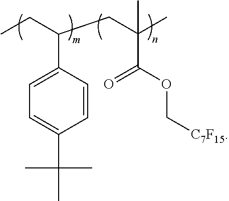

The related test results were shown in Table 6 below.

In the etching performance test, the changes in film thickness of the homopolymers of the two components under the oxygen plasma etching (herein, taking the etching gas oxygen as an example, the gas flow rate was 50 sccm, and the power was 30 W) had significant difference, wherein the film thickness of the PtBS homopolymer film (original film thickness was 280 nm) was reduced by 40 nm after 1 minute of etching, while the film thickness of the PPDFMA (original film thickness was 260 nm) was reduced by 90 nm after 1 minute of etching.

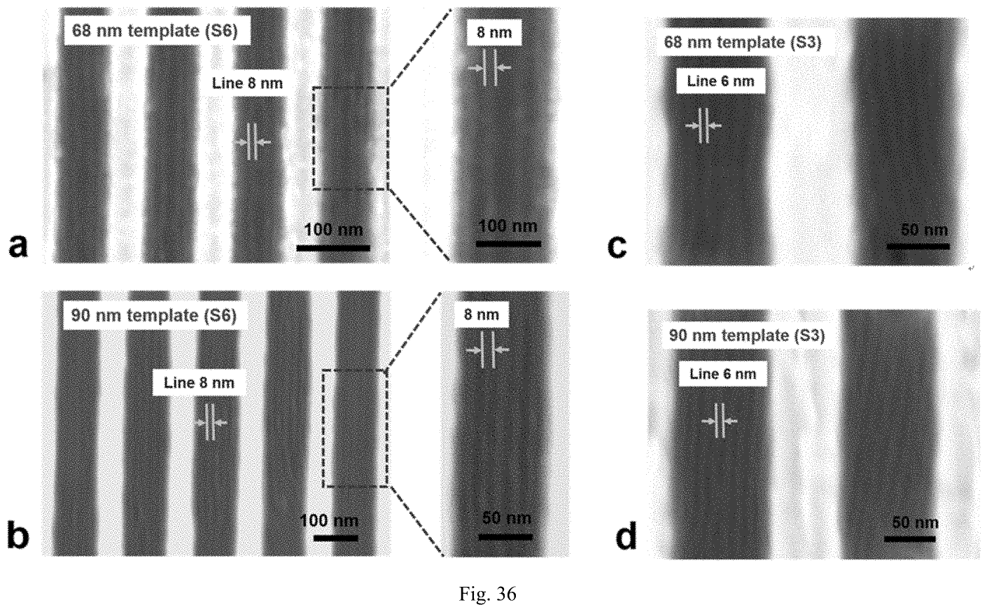

FIG. 36 is the SEM pattern of the guided self-assembly of the block copolymer in Example 5 after annealing in a silicon template.

It can be seen from FIG. 36 that corresponding assembly lines can be obtained by placing the block polymer in different size of templates, and the two components were selectively etched on the corresponding patterns to obtain the striped patterns.

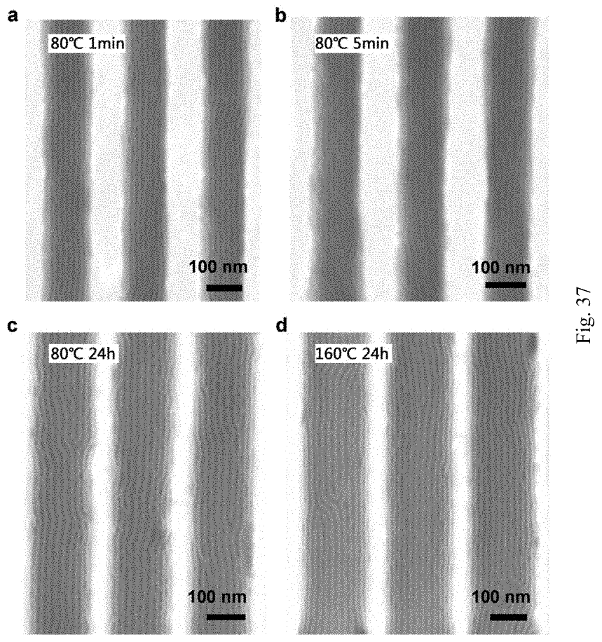

FIG. 37 is the SEM pattern of the guided self-assembly of the block copolymer in Example 6 after annealing in a silicon template.

It can be seen from FIG. 37 that corresponding assembly lines can be obtained by thermal annealing the block polymer in the templates for different periods of time, and then the two components were selectively etched on the corresponding patterns to obtain the striped patterns.

For convenience, relevant parameters and test results of the block copolymers obtained in Examples 2 and 5-12 were summarized in Table 6 below:

TABLE 6
Summary table of relevant parameters and test results of the block copolymers obtained in Examples 2 and 5-12

| | | | | | Annealing | |
|---|---|---|---|---|---|---|
| | | | | | temperature | |
| | | | | Number | and annealing | Self- |
| | | | | average | time required | assembly |
| | | | | molecular | for phase | pitch |
| | | | | weight | separation and | (results of |
| Example | Block polymer | m/n | PDI | [kg mol⁻¹] | self-assembly | SAXS)/nm |
| 2 | 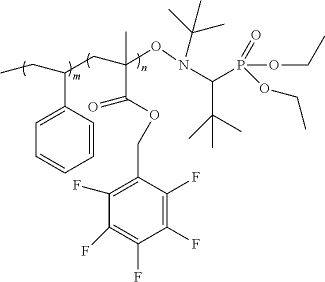 | 1.7 | 1.31 | 17000 | 160° C. 10 h | 28 nm (Hexagonal phase) |
| 5 | 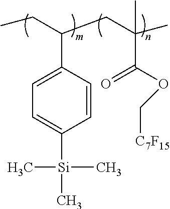 | 3.7 2.6 1.4 4.2 4.5 | 1.13 1.15 1.14 1.16 1.15 | 5800 4500 3800 6200 6800 | 80° C. 5 min | 12.0 nm Layered 10.3 nm Layered 9.5 nm Hexagonal prism 13.3 nm Layered 14.3 nm Layered |
| 6 | 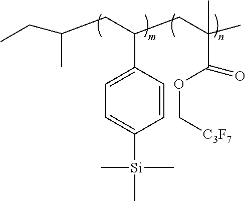 | 2.5 2.2 1.9 3.2 | 1.14 1.15 1.14 1.16 | 5400 4700 4200 6000 | 80° C. 5 min | 12.4 nm Layered 11.2 nm Layered 10.0 nm Layered 13.8 nm Layered |
| 7 | 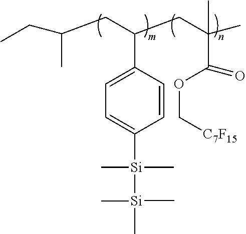 | 1.3 1.8 2.5 | 1.15 1.14 1.16 | 4200 4800 6400 | 80° C. 5 min | 10.6 nm Layered 11.5 nm Layered 13.9 nm Layered |
| 8 | 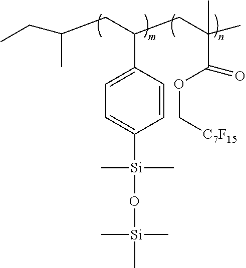 | 1.4 | 1.14 | 6300 | 80° C. 5 min | 14.5 nm Layered |
| 9 | 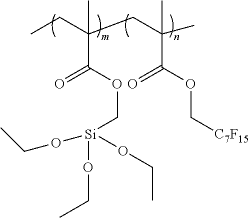 | 2.1 | 1.22 | 5700 | 80° C. 5 min | 14.2 nm Layered |
| 10 | 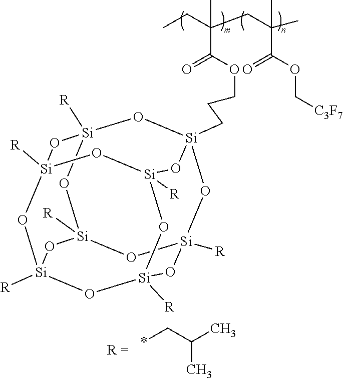 | 0.8 | 1.17 | 6500 | 80° C. 5 min | 16.9 nm Layered |
| 11 | 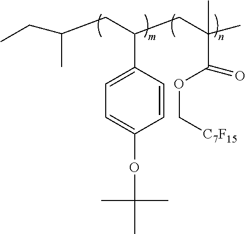 | 3.2 | 1.10 | 11000 | 80° C. 1 min | 18.5 nm Layered |
| | 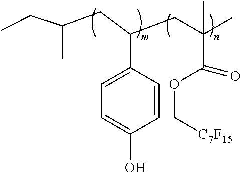 | | 1.10 | 10000 | | 18.1 nm Layered |
| 12 | 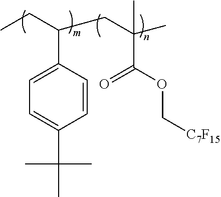 | | 1.14 | 6800 | 80° C. 1 min | 11.2 nm Layered |

The main equipment and parameter information of the characterization means used in the present invention are as follows:

1. ¹H Nuclear Magnetic Resonance Spectroscopy (¹H-NMR)

Instrument model: 400 MHz Fourier transform NMR spectrometer (AVANCE III); using deuterated chloroform and deuterated tetrahydrofuran as solvent in the test, the information such as structure of the material, ratio of components, and molecular weight of polymer and the like were determined by the peak integral of the characteristic peak position of the hydrogen atoms in the structural formula.

### 2. Gel Permeation Chromatography (GPC)

The number-average molecular weight (Mn) and polydispersity index (PDI) were measured by gel chromatography (tetrahydrofuran phase) and corrected by a universal calibration method, and styrene was used as the calibration standard.

### 3. Differential Scanning Calorimetry (DSC)

The present invention used differential scanning calorimetry Q2000 (DSC) to determine the glass-transition temperature (Tg) of the material. The temperature programming was from −60° C. to 160° C. with a heating rate of 10° C. per minute, then the temperature was reduced to −60° C. at the same heating rate, which was recorded as the first cycle, the main role of which was to eliminate the thermal history of the sample. The temperature programming of the second cycle was still from −60° C. to 160° C. with a heating rate of 20° C. per minute. All the results measured in the second cycle were recorded in the DSC diagrams of this application.

### 4. Small-Angle X-Ray Scattering (SAXS)

The structure and size of the polymer material assembly were tested by using small angle X-ray scattering (SAXS) in the present invention, and the assembly size and micromorphology were calculated by the peak positions of the highest peak and the secondary peak and the ratio. The tested sample was a powder or a film of the block copolymer after quenching at a low temperature.

### 5. Grazing Type X Ray Scattering (GISAXS)

The assembly size and morphology of the polymer film material were tested using grazing type X ray scattering (GISAXS) in the present invention, and the commonly used substrate was silicon chip.

### 6. Water Drop Angle Tester

In the present invention, the hydrophilicity or hydrophobicity of the two blocks of the block copolymer were tested by a water drop angle tester.

### 7. Low Temperature Rapid Assembly Quenching Experiment

As shown in FIG. 8, the obtained block copolymer was dissolved in toluene, drop-casted onto a silicon chip, and then baked in a vacuum oven for 2 hours to remove the solvent. The silicon chip was baked at a low temperature on a hot plate, rapid annealing occurred and then quenched with a chill plate. The obtained sample was further measured with SAXS and Transmission Electron Microscope (TEM).

### 8. Etching Performance Test

The etching resistance of the two components in a block polymer was tested using reactive ion etching and film thickness gauge in the present invention. For example, a block copolymer was prepared by polymerization of monomers of component A and component B. In testing the etching contrast, it is necessary to synthesize a homopolymer of the monomer A and a homopolymer of the monomer B, which were then formulated into homopolymer solutions, respectively, and spin-coated on the silicon chip substrate. The original film thickness before etching was measured by a film thickness gauge (average of three measurements), and then the films of the two homopolymers of A and B were subjected to reactive ion etching (using any one of CF₄, O₂, CHF₃, SF₆, Ar, H₂, CO₂, N₂ or a mixture thereof), the power was 10 W-500 W, and the gas flow rate was 2-100 sccm. The etching time was 5 s, 10 s, 15 s, 20 s, 30 s, 45 s, 60 s, and so on, respectively. The film thicknesses of the homopolymers after different etching periods of time were measured by a film thickness gauge (average of three measurements). For different films of the two homopolymers A and B, the etching resistance contrast was calculated and defined based on the difference in reduction of film thickness under the same etching conditions.

In the present invention, “block copolymer” and “block polymer” can be used interchangeably, and a block copolymer, also known as a mosaic copolymer, is a special polymer prepared by linking two or more polymer chain segments having different chemical structures and properties together. By combining the excellent properties of multiple polymers, functional polymer materials with superior performance can be obtained. The block copolymer has a certain self-repairing performance at room temperature, and one of the blocks (which may be any one block) can flow freely in the assembled structure, which to a certain extent makes the assembled edge structure smoother, and thus the defect rate of the assembly is greatly reduced. The initiation end generated during the polymerization, such as the initiation end sec-butyl group

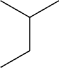

generated by anionic polymerization, and the 1,1-diphenylethylene

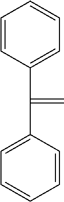

used to stabilize the anion in the two blocks will not affect the phase separation and assembling structure of the block copolymer.

Similarly, the

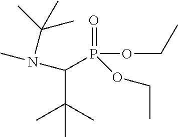 [SMILES: CCOP(=O)(OCC)C(N(C)C(C)(C)C)C(C)(C)C]

initiating end in the polymerization of the nitroxyl radical, the initiator for atom transfer radical polymerization (ATRP), such as halogenated alkane RX (X=Br or Cl), benzyl halide, α-bromo ester, α-haloketone, α-halonitrile, reversible addition-fragmentation chain transfer polymerization (RAFT) disulfatide and trisulfatide and the like will not affect the phase separation and assembling structure of the block copolymer. Therefore, the block polymer structures containing the above groups are considered to be equivalent to those not containing the groups. The phase separation self-assembly of the block copolymer was carried out during a low temperature quenching process.

In summary, the present invention provides a block copolymer, a preparation method and an application thereof, wherein the block copolymer can assemble rapidly at a low temperature and has potential self-repairing performance to reduce the defect rate. In addition, a metal ion can also be introduced during the subsequent conversion process of the functional groups, thereby improving its etching resistance, and having a good application prospect in the fields of catalysis, photoelectricity and magnetism as well.

The above contents are only examples of the present invention, and are not intended to limit the patent scope of the present invention. Any equivalent transformations made by means of description and drawings of the present invention, or applications directly or indirectly in related technical fields, are similarly included within the patent protection scope of the present invention.

1. A block copolymer comprising at least a block A and a block B, wherein the monomer of block A is selected from the group consisting of: 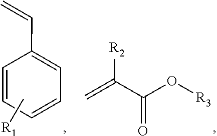
C3-C6 alkenyl having a substituent or C3-C6 alkenyl;
wherein R₁ is selected from the group consisting of H, substituted or unsubstituted silane group containing 1-5 Si atom(s), substituted or unsubstituted germane group containing 1-5 Ge atom(s), substituted or unsubstituted stannane group containing 1-5 Sn atom(s), substituted or unsubstituted C1-C10 alkyl group, substituted or unsubstituted hydrocabyloxy group, substituted or unsubstituted ester group, substituted or unsubstituted C3-C6 cycloalkyl group, substituted or unsubstituted C6-C10 aryl group, substituted or unsubstituted heteroaryl group containing 1-3 heteroatoms selected from N, O, and S, hydroxyl group, and halogen; wherein “substituted” means that a group is substituted by one or more of the substituents selected from the group consisting of: C1-C6 alkyl, silane group containing 1-5 Si atom(s), C1-C6 alkoxyl-substituted silane group containing 1-5 Si atom(s), silyloxy group containing 1-5 Si atom(s), silyloxy group containing 1-5 Si atom(s) substituted by silyloxy group containing 1-5 Si atom(s), C1-C6 alkoxyl group, and hydroxyl group;
the number of R₁ is 0, 1, 2, 3, 4 or 5;
R₂ is selected from the group consisting of: absent, substituted or unsubstituted C1-C6 alkyl, substituted or unsubstituted C1-C6 alkoxyl, hydroxyl, halogen; “substituted” means that a group is substituted by one or more substituents selected from the group consisting of halogen and hydroxyl;
R₃ is selected from the group consisting of substituted C1-C10 alkyl, substituted or unsubstituted C3-C6 cycloalkyl, substituted or unsubstituted C6-C10 aryl, substituted or unsubstituted C6-C10 heteroaryl group containing 1-3 heteroatoms selected from N, O, and S, substituted or unsubstituted silane group containing 1-5 Si atom(s), substituted or unsubstituted germane group containing 1-5 Ge atom(s), substituted or unsubstituted stannane group containing 1-5 Sn atom(s); “substituted” means that a group is substituted by one or more substituents selected from the group consisting of: C1-C6 alkyl, silane group containing 1-5 Si atom(s), C1-C₆ alkyl-substituted silane group containing 1-5 Si atom(s), C1-C6 alkyl-substituted silyloxy group containing 1-5 Si atom(s), silane group containing 1-5 Si atom(s) substituted by silyloxy group containing 1-5 Si atom(s), C1-C6 alkoxyl-substituted silane group containing 1-5 Si atom(s), silyloxy group containing 1-5 Si atom(s), and C1-C6 alkyl-substituted caged siloxane group containing 4-10 Si atoms;
in the substituted or unsubstituted C3-C6 alkenyl group, “substituted” means the group is substituted by one or more substituents selected from the group consisting of: silyloxy group containing 1-5 Si atom(s), silane group containing 1-5 Si atom(s), C1-C6 alkyl-substituted silane group containing 1-5 Si atom(s), C1-C6 alkoxyl-substituted silane group containing 1-5 Si atom(s), and C6-C10 aryl-substituted silane group containing 1-5 Si atom(s);
block B is obtained by polymerization of the following monomer: 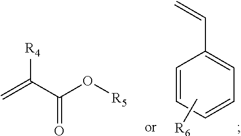
wherein, R₄ is selected from the group consisting of: absent, substituted or unsubstituted C1-C6 alkyl, substituted or unsubstituted C1-C6 alkoxyl, hydroxyl, halogen; “substituted” means that the group is substituted by one or more substituents selected from the group consisting of halogen and hydroxyl;
R₅ is selected from the group consisting of substituted benzyl, substituted C3-C30 alkyl; “substituted” means that the group is substituted by 1-3 hydroxyl groups and/or 5-20 F atoms;
provided that: when block A is obtained by polymerization of 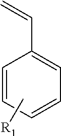
in which R₁ is absent, R₅ is a substituted benzyl group;
R₆ is selected from the group consisting of F or a group containing F, and the number of R₆ is 0, 1, 2, 3, 4 or 5.

2. The block copolymer according to claim 1, wherein the number of alkyl group in the hydrocarbyloxy group or the ester group is 0-20.

3. The block copolymer according to claim 1, wherein block A is obtained by polymerization of a monomer selected from the group consisting of: 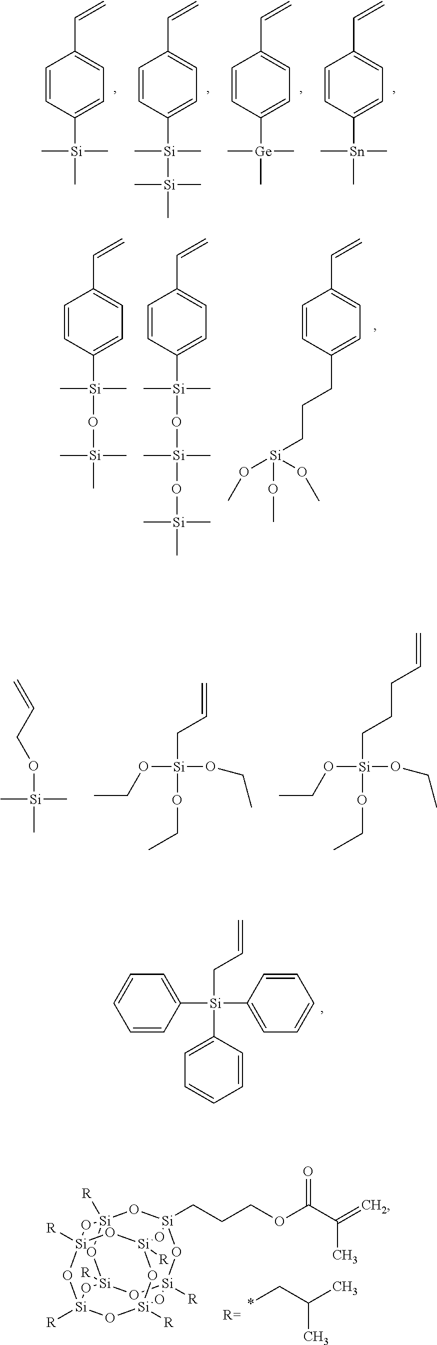 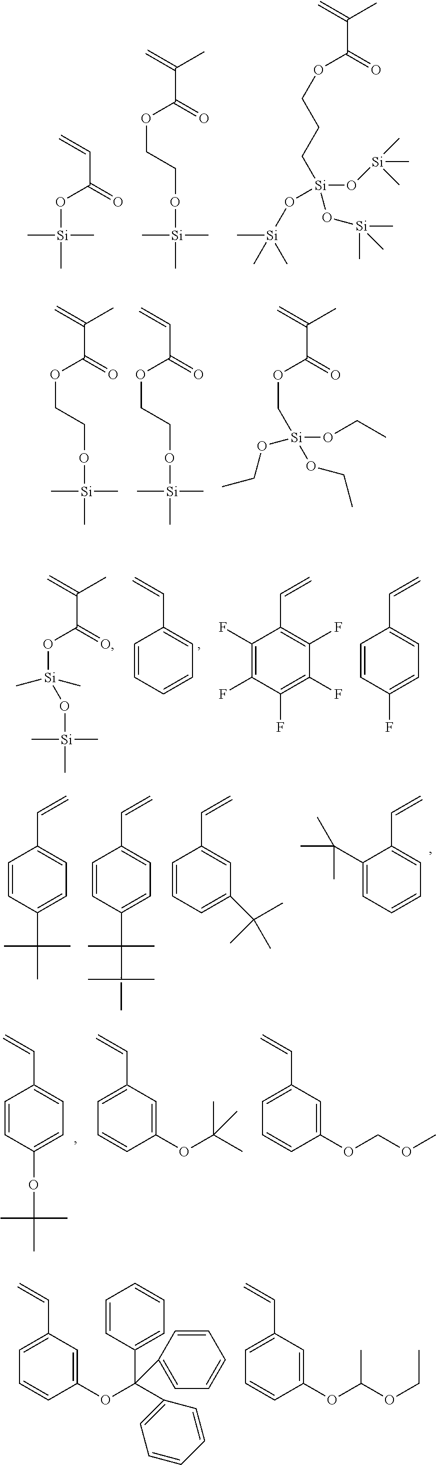 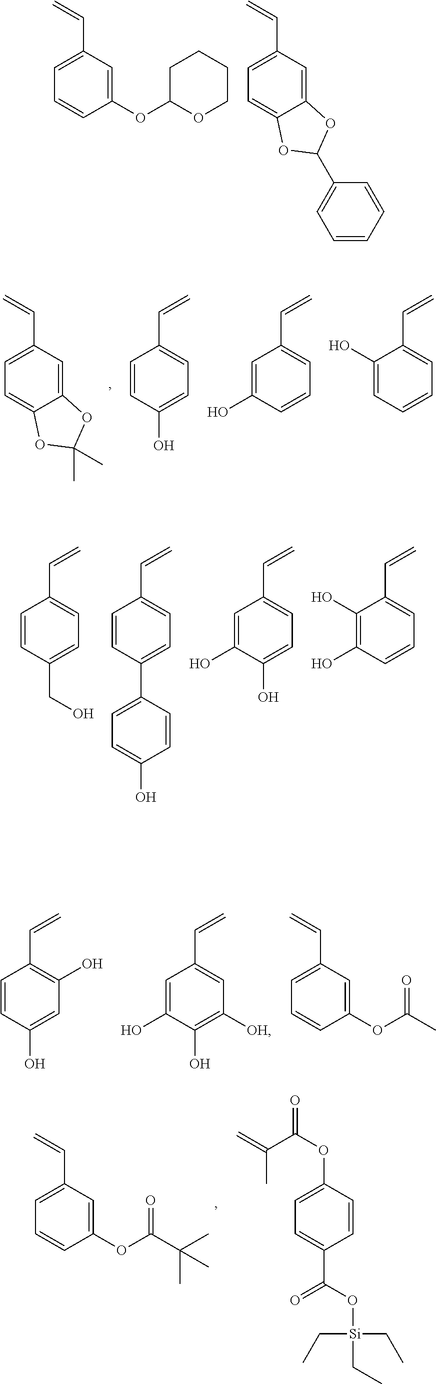 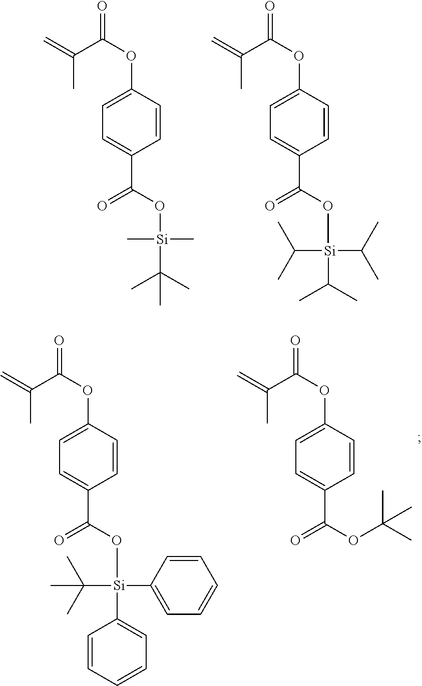
block B is obtained by polymerization of a monomer selected from the group consisting of: 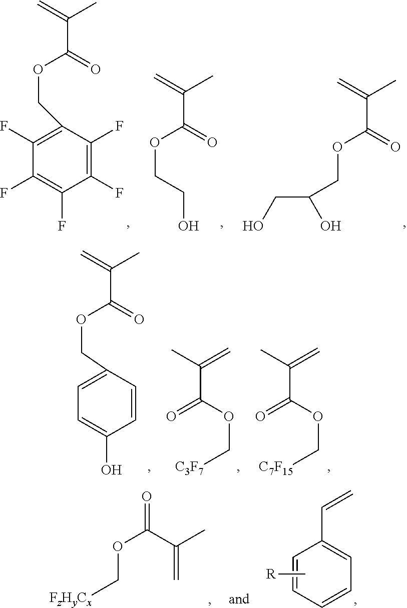
wherein, the x, y, and z are random natural numbers, and the R is F or —CF₃ or —COCF₃.

4. The block copolymer according to claim 1, wherein, when block A is obtained by polymerization of 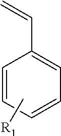
in which R₁ is absent, the block copolymer has a molecular weight of 2000-30000.

5. The block copolymer according to claim 1, wherein the block copolymer has a di-block structure of (A)ₘ-(B)ₙ or a tri-block structure of (B)ₙ₁-(A)ₘ-(B)ₙ₂.

6. The block copolymer according to claim 5, wherein the block copolymer has a characteristic selected from the group consisting of:
1) m/n=0.2-5;
2) m/(n1+n2)=0.2-5.

7. The block copolymer according to claim 1, wherein the block copolymer has one or more characteristics selected from the group consisting of:
1) the block copolymer has a polydispersity PDI≤2.0;
2) the block copolymer has a number average molecular weight of 1000-200000; when block A is obtained not by polymerization of 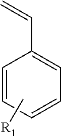
in which R₁ is absent, the block copolymer has a number average molecular weight of 1000-120000;
3) the annealing temperature required for phase separation and self-assembly of the block copolymer is ≤200; when block A is obtained not by polymerization of 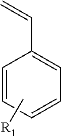
in which R₁ is absent, the annealing temperature required for phase separation and self-assembly of the block copolymer is ≤100° C.; and/or the annealing time required for phase separation and self-assembly of the block copolymer is ≤10 min;
4) the annealing time required for phase separation and self-assembly of the block copolymer is ≤24 h; when block A is obtained by polymerization of 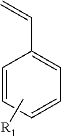
in which R₁ is absent, the annealing temperature required for phase separation and self-assembly of the block copolymer is ≤180° C.; and/or the annealing time required for phase separation and self-assembly of the block copolymer is ≤12 h;
5) the assembly pitch of the product obtained by self-assembly of the block copolymer is ≤30 nm.

8. The block copolymer according to claim 1, wherein the block copolymer is selected from the group consisting of:

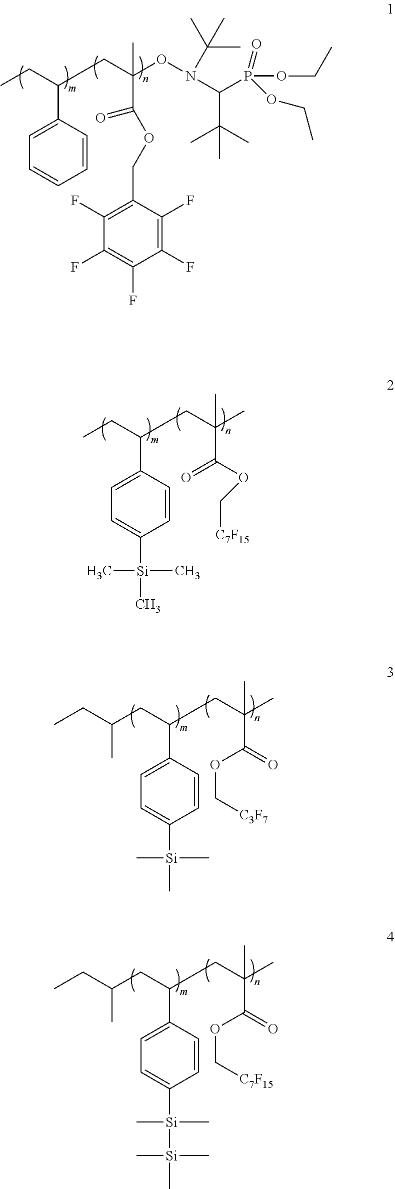

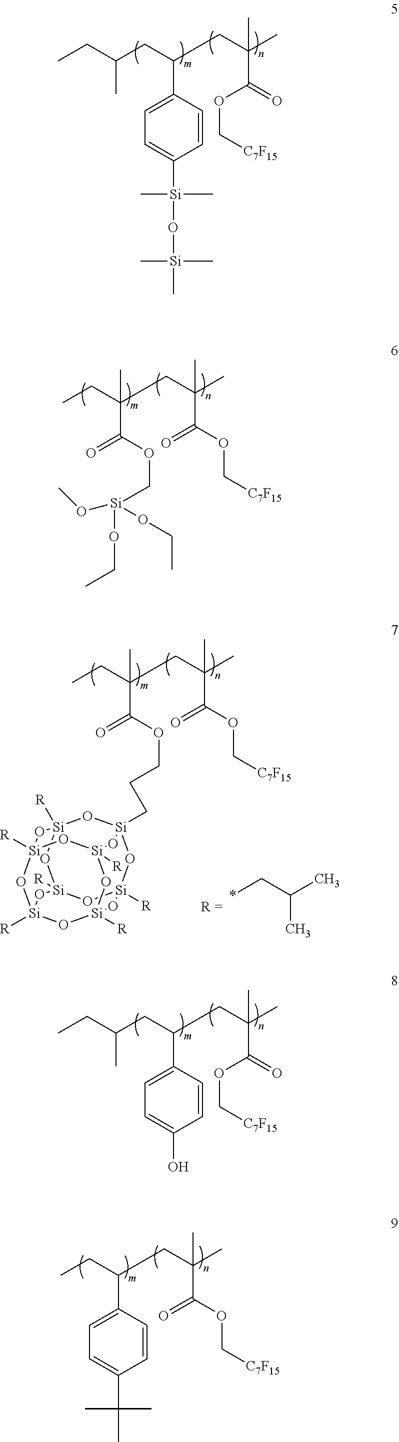

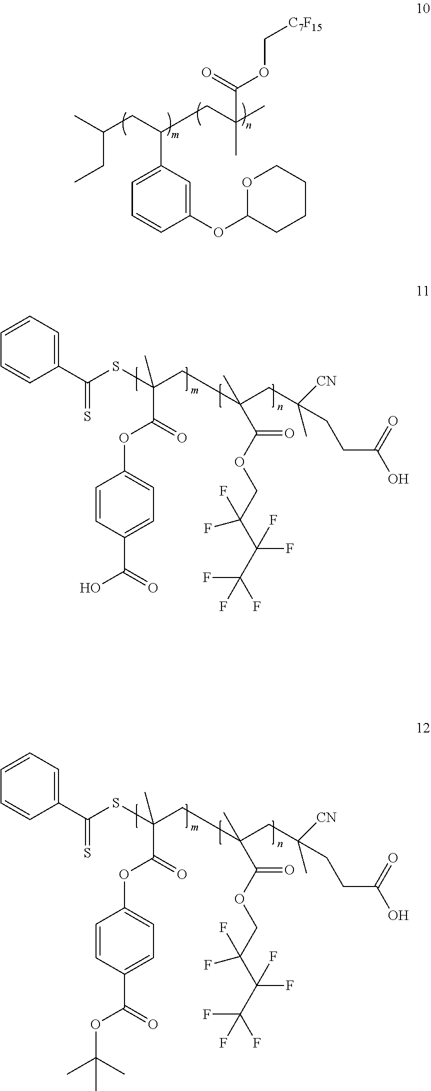

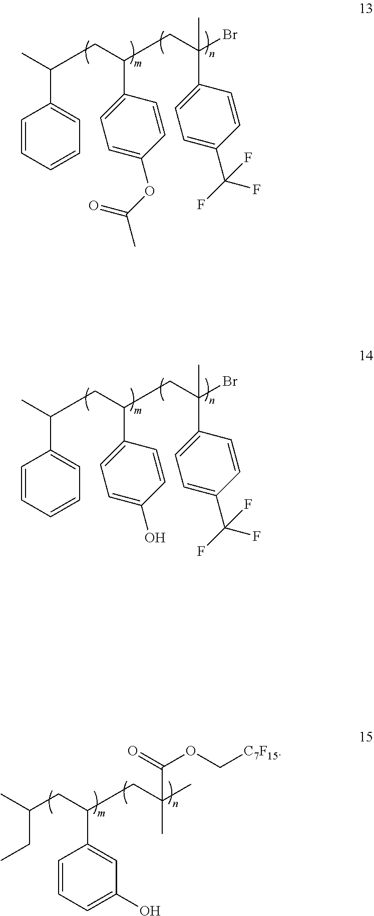

9. A preparation method of the block copolymer according to claim 1, wherein the method comprises the following steps:
S1, selecting a monomer of block A and a monomer of block B, wherein,
the monomer of block A and the monomer of block B are as described in claim 1;
S2, polymerizing the monomer of block A to obtain block A, and polymerizing with monomer of block B in the presence of block A to obtain the block copolymer as described in claim 1.

10. The preparation method of the block copolymer according to claim 9, wherein the preparation method further includes a step of deprotecting the compound obtained by polymerizing block A with monomer of block B to obtain the block copolymer.

11. An application of the block copolymer according to claim 1 in manufacture of a DSA-guided self-assembling material, a nanocatalyst, a functionalized nanoelectronic device, a nano energy storage device, a portable precision storage material, and/or a biomedical nanodevice.
